(19) United States
(12) Patent Application Publication
(10) Pub. No.: US 2015/0322874 A1
(43) Pub. Date: Nov. 12, 2015

(54) POWER GENERATION SYSTEMS AND METHODS

(71) Applicant: SCUDERI GROUP, INC., West Springfield, MA (US)

(72) Inventors: Nicholas Joseph Scuderi, Feeding Hills, MA (US); Salvatore C. Scuderi, Westfield, MA (US); Stephen P. Scuderi, Westfield, MA (US)

(73) Assignee: SCUDERI GROUP, INC., West Springfield, MA (US)

(21) Appl. No.: 14/708,324

(22) Filed: May 11, 2015

Related U.S. Application Data
(60) Provisional application No. 61/991,457, filed on May 10, 2014.
(60) Provisional application No. 62/000,649, filed on May 20, 2014.
(60) Provisional application No. 62/083,375, filed on Nov. 24, 2014.
(60) Provisional application No. 62/120,770, filed on Feb. 25, 2015.

(51) Int. Cl. F02D 29/06; G05B 15/02; F02C 9/00; F02B 33/06; F02B 63/04; F02C 6/00

(52) U.S. Cl. CPC F02D 29/06; F02B 63/04; F02C 6/00; F02C 9/00; F02B 33/06; G05B 15/02; F05D 2220/32; F05D 2220/76; F05D 2270/20

(57) ABSTRACT

A number of exemplary power generation systems and methods are disclosed herein. In some embodiments, a compressed air energy storage system, optionally with split-cycle engine technology, is used to store energy obtained from the grid during off-peak hours and to supply stored energy to the grid and/or to an end user during on-peak hours. The system can include heat recovery features and can supply heat to the end user. In some embodiments, a generator system is used to provide power to an end user and to the grid. The generator can be maintained in a high efficiency operating range (e.g., at elevated or full load), even when the generator output exceeds the end user's demand, with any excess generated power being fed to the grid.

### CROSS-REFERENCE TO RELATED APPLICATIONS

This application claims the benefit of U.S. Provisional Application No. 61/991,457, filed May 10, 2014, U.S. Provisional Application No. 62/000,649, filed May 20, 2014, U.S. Provisional Application No. 62/083,375, filed Nov. 24, 2014, and U.S. Provisional Application No. 62/120,770, filed Feb. 25, 2015, each of which is hereby incorporated by reference herein in its entirety.

### FIELD

Power generation systems and methods (e.g., compressed air energy storage systems and related methods) are disclosed herein. In some embodiments, compressed air energy storage systems and related methods involve split-cycle internal combustion engines.

### BACKGROUND

Engine Technology

For purposes of clarity, the term “conventional engine” as used in the present application refers to an internal combustion engine wherein all four strokes of the well-known Otto cycle (the intake, compression, expansion and exhaust strokes) are contained in each piston/cylinder combination of the engine. Each stroke requires one half revolution of the crankshaft (180 degrees crank angle (“CA”)), and two full revolutions of the crankshaft (720 degrees CA) are required to complete the entire Otto cycle in each cylinder of a conventional engine.

Also, for purposes of clarity, the following definition is offered for the term “split-cycle engine” as may be applied to engines disclosed in the prior art and as referred to in the present application.

A split-cycle engine generally comprises:

one or more crankshafts rotatable about one or more crankshaft axes;

a compression piston slidably received within a compression cylinder and operatively connected to at least one of the one or more crankshafts such that the compression piston reciprocates through an intake stroke and a compression stroke during a single rotation of said at least one crankshaft;

an expansion (power) piston slidably received within an expansion cylinder and operatively connected to at least one of the one or more crankshafts such that the expansion piston reciprocates through an expansion stroke and an exhaust stroke during a single rotation of said at least one crankshaft; and

a crossover passage interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween.

In some embodiments, the split-cycle engine can be an engine having a compression piston and an expansion piston operatively connected to a single crankshaft. In other embodiments, the split-cycle engine can comprise a system with a standalone compressor operatively connected to a first crankshaft and a standalone expander operatively coupled to a second crankshaft that is separate from the first crankshaft.

A split-cycle air hybrid engine combines a split-cycle engine with an air reservoir (also commonly referred to as an air tank) and various controls. This combination enables the engine to store energy in the form of compressed air in the air reservoir. The compressed air in the air reservoir is later used in the expansion cylinder to power at least one crankshaft. In general, a split-cycle air hybrid engine as referred to herein comprises:

one or more crankshafts rotatable about one or more crankshaft axes;

a compression piston slidably received within a compression cylinder and operatively connected to at least one of the one or more crankshafts such that the compression piston reciprocates through an intake stroke and a compression stroke during a single rotation of said at least one crankshaft;

an expansion (power) piston slidably received within an expansion cylinder and operatively connected to at least one of the one or more crankshafts such that the expansion piston reciprocates through an expansion stroke and an exhaust stroke during a single rotation of said at least one crankshaft;

a crossover passage (port) interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween; and

an air reservoir operatively connected to the crossover passage and selectively operable to store compressed air from the compression cylinder and to deliver compressed air to the expansion cylinder.

FIG. 1 illustrates one exemplary embodiment of a prior art split-cycle air hybrid engine in which the compression piston and the expansion piston are operatively connected to a single crankshaft. The split-cycle engine 100 replaces two adjacent cylinders of a conventional engine with a combination of one compression cylinder 102 and one expansion cylinder 104. The compression cylinder 102 and the expansion cylinder 104 are formed in an engine block in which a crankshaft 106 is rotatably mounted. Upper ends of the cylinders 102, 104 are closed by a cylinder head 130. The crankshaft 106 includes axially displaced and angularly offset first and second crank throws 126, 128, having a phase angle therebetween. The first crank throw 126 is pivotally joined by a first connecting rod 138 to a compression piston 110, and the second crank throw 128 is pivotally joined by a second connecting rod 140 to an expansion piston 120 to reciprocate the pistons 110, 120 in their respective cylinders 102, 104 in a timed relation determined by the angular offset of the crank throws and the geometric relationships of the cylinders, crank, and pistons. Alternative mechanisms for relating the motion and timing of the pistons can be utilized if desired. The rotational direction of the crankshaft and the relative motions of the pistons near their bottom dead center (BDC) positions are indicated by the arrows associated in the drawings with their corresponding components.

The four strokes of the Otto cycle are thus “split” over the two cylinders 102 and 104 such that the compression cylinder 102 contains the intake and compression strokes and the expansion cylinder 104 contains the expansion and exhaust strokes. The Otto cycle is therefore completed in these two cylinders 102, 104 once per crankshaft 106 revolution (360 degrees CA).

During the intake stroke, intake air is drawn into the compression cylinder 102 through an inwardly-opening (opening inward into the cylinder and toward the piston) poppet intake valve 108. During the compression stroke, the compression piston 110 pressurizes the air charge and drives the air charge through a crossover passage 112, which acts as the intake passage for the expansion cylinder 104. The engine 100 can have one or more crossover passages 112.

The volumetric (or geometric) compression ratio of the compression cylinder 102 of the split-cycle engine 100 (and for split-cycle engines in general) is herein referred to as the “compression ratio” of the split-cycle engine. The volumetric (or geometric) compression ratio of the expansion cylinder 104 of the engine 100 (and for split-cycle engines in general) is herein referred to as the “expansion ratio” of the split-cycle engine. The volumetric compression ratio of a cylinder is well known in the art as the ratio of the enclosed (or trapped) volume in the cylinder (including all recesses) when a piston reciprocating therein is at its BDC position to the enclosed volume (i.e., clearance volume) in the cylinder when said piston is at its top dead center (TDC) position. Specifically for split-cycle engines as defined herein, the compression ratio of a compression cylinder is determined when the XovrC valve is closed. Also specifically for split-cycle engines as defined herein, the expansion ratio of an expansion cylinder is determined when the XovrE valve is closed.

Due to very high volumetric compression ratios (e.g., 20 to 1, 30 to 1, 40 to 1, or greater) within the compression cylinder 102, an outwardly-opening (opening outwardly away from the cylinder and piston) poppet crossover compression (XovrC) valve 114 at the inlet of the crossover passage 112 is used to control flow from the compression cylinder 102 into the crossover passage 112. Due to very high volumetric compression ratios (e.g., 20 to 1, 30 to 1, 40 to 1, or greater) within the expansion cylinder 104, an outwardly-opening poppet crossover expansion (XovrE) valve 116 at the outlet of the crossover passage 112 controls flow from the crossover passage 112 into the expansion cylinder 104. The actuation rates and phasing of the XovrC and XovrE valves 114, 116 are timed to maintain pressure in the crossover passage 112 at a high minimum pressure (typically 20 bar or higher at full load) during all four strokes of the Otto cycle.

At least one fuel injector 118 injects fuel into the pressurized air at the exit end of the crossover passage 112 in coordination with the XovrE valve 116 opening. Alternatively, or in addition, fuel can be injected directly into the expansion cylinder 104. The fuel-air charge fully enters the expansion cylinder 104 shortly after the expansion piston 120 reaches its TDC position. As the piston 120 begins its descent from its TDC position, and while the XovrE valve 116 is still open, one or more spark plugs 122 are fired to initiate combustion (typically between 10 to 20 degrees CA after TDC of the expansion piston 120). Combustion can be initiated while the expansion piston is between 1 and 30 degrees CA past its TDC position. More preferably, combustion can be initiated while the expansion piston is between 5 and 25 degrees CA past its TDC position. Most preferably, combustion can be initiated while the expansion piston is between 10 and 20 degrees CA past its TDC position. Additionally, combustion can be initiated through other ignition devices and/or methods, such as with glow plugs, microwave ignition devices, or through compression ignition methods.

The XovrE valve 116 is then closed before the resulting combustion event enters the crossover passage 112. The combustion event drives the expansion piston 120 downward in a power stroke. Exhaust gases are pumped out of the expansion cylinder 104 through an inwardly-opening poppet exhaust valve 124 during the exhaust stroke.

With the split-cycle engine concept, the geometric engine parameters (i.e., bore, stroke, connecting rod length, compression ratio, etc.) of the compression and expansion cylinders are generally independent from one another. For example, the crank throws 126, 128 for the compression cylinder 102 and expansion cylinder 104, respectively, have different radii and are phased apart from one another with TDC of the expansion piston 120 occurring prior to TDC of the compression piston 110. This independence enables the split-cycle engine to potentially achieve higher efficiency levels and greater torques than typical four-stroke engines.

The geometric independence of engine parameters in the split-cycle engine 100 is also one of the main reasons why pressure can be maintained in the crossover passage 112 as discussed earlier. Specifically, the expansion piston 120 reaches its TDC position prior to the compression piston 110 reaching its TDC position by a discrete phase angle (typically between 10 and 30 crank angle degrees). This phase angle, together with proper timing of the XovrC valve 114 and the XovrE valve 116, enables the split-cycle engine 100 to maintain pressure in the crossover passage 112 at a high minimum pressure (typically 20 bar absolute or higher during full load operation) during all four strokes of its pressure/volume cycle. That is, the split-cycle engine 100 is operable to time the XovrC valve 114 and the XovrE valve 116 such that the XovrC and XovrE valves 114, 116 are both open for a substantial period of time (or period of crankshaft rotation) during which the expansion piston 120 descends from its TDC position towards its BDC position and the compression piston 110 simultaneously ascends from its BDC position towards its TDC position. During the period of time (or crankshaft rotation) that the crossover valves 114, 116 are both open, a substantially equal mass of gas is transferred (1) from the compression cylinder 102 into the crossover passage 112 and (2) from the crossover passage 112 to the expansion cylinder 104. Accordingly, during this period, the pressure in the crossover passage is prevented from dropping below a predetermined minimum pressure (typically 20, 30, or 40 bar absolute during full load operation). Moreover, during a substantial portion of the intake and exhaust strokes (typically 90% of the entire intake and exhaust strokes or greater), the XovrC valve 114 and XovrE valve 116 are both closed to maintain the mass of trapped gas in the crossover passage 112 at a substantially constant level. As a result, the pressure in the crossover passage 112 is maintained at a predetermined minimum pressure during all four strokes of the engine's pressure/volume cycle.

For purposes herein, the method of opening the XovrC 114 and XovrE 116 valves while the expansion piston 120 is descending from TDC and the compression piston 110 is ascending toward TDC in order to simultaneously transfer a substantially equal mass of gas into and out of the crossover passage 112 is referred to as the “push-pull” method of gas transfer. It is the push-pull method that enables the pressure in the crossover passage 112 of the engine 100 to be maintained at typically 20 bar or higher during all four strokes of the engine's cycle when the engine is operating at full load.

The crossover valves 114, 116 are actuated by a valve train that includes one or more cams (not shown). In general, a cam-driven mechanism includes a camshaft mechanically linked to the crankshaft. One or more cams are mounted to the camshaft, each having a contoured surface that controls the valve lift profile of the valve event (i.e., the event that occurs during a valve actuation). The XovrC valve 114 and the XovrE valve 116 each can have its own respective cam and/or its own respective camshaft. As the XovrC and XovrE cams rotate, eccentric portions thereof impart motion to a rocker arm, which in turn imparts motion to the valve, thereby lifting (opening) the valve off of its valve seat. As the cam continues to rotate, the eccentric portion passes the rocker arm and the valve is allowed to close.

The split-cycle air hybrid engine 100 also includes an air reservoir (tank) 142, which is operatively connected to the crossover passage 112 by an air reservoir tank valve 152. Embodiments with two or more crossover passages 112 may include a tank valve 152 for each crossover passage 112 which connect to a common air reservoir 142, may include a single valve which connects all crossover passages 112 to a common air reservoir 142, or each crossover passage 112 may operatively connect to separate air reservoirs 142.

The tank valve 152 is typically disposed in an air tank port 154, which extends from the crossover passage 112 to the air tank 142. The air tank port 154 is divided into a first air tank port section 156 and a second air tank port section 158. The first air tank port section 156 connects the air tank valve 152 to the crossover passage 112, and the second air tank port section 158 connects the air tank valve 152 to the air tank 142. The volume of the first air tank port section 156 includes the volume of all additional recesses which connect the tank valve 152 to the crossover passage 112 when the tank valve 152 is closed. Preferably, the volume of the first air tank port section 156 is small relative to the second air tank port section 158. More preferably, the first air tank port section 156 is substantially non-existent, that is, the tank valve 152 is most preferably disposed such that it is flush against the outer wall of the crossover passage 112.

The tank valve 152 may be any suitable valve device or system. For example, the tank valve 152 may be an active valve which is activated by various valve actuation devices (e.g., pneumatic, hydraulic, cam, electric, or the like). Additionally, the tank valve 152 may comprise a tank valve system with two or more valves actuated with two or more actuation devices.

The air tank 142 is utilized to store energy in the form of compressed air and to later use that compressed air to power the crankshaft 106. This mechanical means for storing potential energy provides numerous potential advantages over the current state of the art. For instance, the split-cycle air hybrid engine 100 can potentially provide many advantages in fuel efficiency gains and NOx emissions reduction at relatively low manufacturing and waste disposal costs in relation to other technologies on the market, such as diesel engines and electric-hybrid systems.

The engine 100 typically runs in a normal operating or firing (NF) mode (also commonly called the engine firing (EF) mode) and one or more of four basic air hybrid modes. In the EF mode, the engine 100 functions normally as previously described in detail herein, operating without the use of the air tank 142. In the EF mode, the air tank valve 152 remains closed to isolate the air tank 142 from the basic split-cycle engine. In the four air hybrid modes, the engine 100 operates with the use of the air tank 142.

The four basic air hybrid modes include:

1) Air Expander (AE) mode, which includes using compressed air energy from the air tank 142 without combustion;

2) Air Compressor (AC) mode, which includes storing compressed air energy into the air tank 142 without combustion;

3) Air Expander and Firing (AEF) mode, which includes using compressed air energy from the air tank 142 with combustion; and

4) Firing and Charging (FC) mode, which includes storing compressed air energy into the air tank 142 with combustion.

Further details on split-cycle engines can be found in U.S. Pat. No. 6,543,225 entitled Split Four Stroke Cycle Internal Combustion Engine and issued on Apr. 8, 2003; and U.S. Pat. No. 6,952,923 entitled Split-Cycle Four-Stroke Engine and issued on Oct. 11, 2005, each of which is incorporated by reference herein in its entirety.

Further details on air hybrid engines are disclosed in U.S. Pat. No. 7,353,786 entitled Split-Cycle Air Hybrid Engine and issued on Apr. 8, 2008; U.S. Patent Application No. 61/365,343 entitled Split-Cycle Air Hybrid Engine and filed on Jul. 18, 2010; and U.S. Patent Application No. 61/313,831 entitled Split-Cycle Air Hybrid Engine and filed on Mar. 15, 2010, each of which is incorporated by reference herein in its entirety.

Power Systems

Compressed air energy storage (CAES) systems, including CAES systems that employ split-cycle engines, are disclosed in U.S. Publication No. 2013/0269632 filed Apr. 9, 2013 and entitled “COMPRESSED AIR ENERGY STORAGE SYSTEMS WITH SPLIT-CYCLE ENGINES,” which is hereby incorporated by reference herein in its entirety. Additional power systems are disclosed in U.S. application Ser. No. 14/543,223 filed Nov. 17, 2014 and entitled “POWER GENERATION SYSTEMS AND METHODS,” which is hereby incorporated by reference herein in its entirety.

A CAES system can include various devices for storing energy in the form of compressed air and for converting energy stored as compressed air into other forms, such as electrical power. FIG. 2 illustrates a dedicated or standalone expander 200 which can be used independently, in a split-cycle engine system, or in any of a variety of other power generation systems to convert energy stored as compressed air into rotational power (e.g., for the purpose of turning a generator to produce electrical power). The expander 200 can be supplied with compressed air from various sources (e.g., an air tank filled with compressed air, or a compressor having its own crankshaft that is distinct from and not operatively coupled to the expander crankshaft).

As shown, the expander 200 includes an expansion cylinder 202 having an expansion piston 204 reciprocally disposed therein. A connecting rod 206 couples the expansion piston 204 to a crankshaft 208. The top of the expansion cylinder 202 is closed by a cylinder head 212 having an intake valve 214 and an exhaust valve 216 disposed therein, along with a fuel injector 218 and a spark plug 220. (In embodiments in which diesel fuel is used, the spark plug 220 can be omitted and compression ignition can be used to initiate combustion.) The intake valve 214 controls fluid communication between a source of compressed air 222 (e.g., a storage tank or a separate compressor) and the expansion cylinder 202, and the exhaust valve 216 controls fluid communication between the expansion cylinder 202 and an exhaust passage 224.

In operation, compressed air stored in the air storage tank 222 is supplied to the expansion cylinder 202 through the intake valve 214 as the expansion piston reaches top dead center. The fuel injector 218 is then actuated to add fuel to the compressed air charge in the expansion cylinder 202, and the spark plug 220 is fired just after the expansion piston 204 reaches top dead center to ignite the air-fuel mixture. The resulting combustion drives the expansion piston 204 down in a power stroke, rotating the crankshaft 208 about the crankshaft axis 210. After the expansion piston 204 reaches bottom dead center and begins ascending within the cylinder 202, the exhaust valve 216 is opened to allow combustion products to be evacuated from the cylinder 202 by the rising expansion piston 204 in an exhaust stroke. The exhaust valve 216 is closed shortly before the piston 204 reaches top dead center, and before the intake valve 214 is opened in the next cycle. This cycle of a power (or “expansion”) stroke and an exhaust stroke then repeats.

The air expander 200 of FIG. 2 is also capable of operating in any of the air hybrid modes described above, including, for example, AE mode operation and AEF mode operation. It will be appreciated that the structure and function of the air expander described above is merely exemplary and that a number of variations are possible. For example, any of the variations described above with respect to split-cycle engines can be applied to the air expander 200.

A number of exemplary split-cycle engine operating cycles are disclosed in U.S. Publication No. 2014/0261325 filed Mar. 13, 2014 and entitled “SPLIT-CYCLE ENGINES WITH DIRECT INJECTION,” which is hereby incorporated by reference herein in its entirety. The air expander 200 can execute the expansion portion of any of the operating cycles described in this reference. For example, the expander 200 can be operable in a four-stroke mode in which two rotations of the crankshaft 208 are required to complete one cycle. During a first rotation of the crankshaft 208, the valves 214, 216 are closed as the piston 204 descends to bottom dead center and returns to top dead center. Fuel is injected into the cylinder 202 during the piston's descent and/or during the piston's ascent. When the piston 204 is at or near top dead center, the intake valve 214 is opened to supply the air required to combust the injected fuel. The air-fuel mixture is then ignited and the expander 200 executes the power and exhaust strokes described above during the second rotation of the crankshaft 208, thereby completing the cycle.

Exemplary valve actuation systems and methods which can be applied to a split-cycle engine or to an air expander are disclosed in U.S. Publication No. 2013/0152889 filed Dec. 14, 2012 and entitled “LOST-MOTION VARIABLE VALVE ACTUATION SYSTEM,” which is hereby incorporated by reference herein in its entirety.

### SUMMARY

A number of exemplary power generation systems and methods are disclosed herein. In some embodiments, a compressed air energy storage system, optionally with split-cycle engine technology, is used to store energy obtained from the grid during off-peak hours and to supply stored energy to the grid and/or to an end user during on-peak hours. The system can include heat recovery features and can supply heat to the end user. In some embodiments, a generator system is used to provide power to an end user and to the grid. The generator can be maintained in a high efficiency operating range (e.g., at elevated or full load), even when the generator output exceeds the end user's demand, with any excess generated power being fed to the grid.

In one aspect of at least one embodiment, a power system includes a generator configured to burn fuel and generate electrical power; a first connection between the generator and a power grid through which power generated by the generator can be supplied to the power grid; a second connection between the generator and an end user through which power generated by the generator can be supplied to the end user; and a controller configured to operate the generator within a high efficiency range such that the end user is supplied with power through the second connection and such that any power generated in excess of the end user's demand is supplied to the grid through the first connection.

Related aspects of at least one embodiment provide a system, e.g., as described above, that includes a third connection between the power grid and the end user through which grid power can be supplied to the end user and in which the controller is configured to: during off-peak hours, deactivate the generator such that the end user is supplied with power only through the third connection; and during on-peak hours, operate the generator within a high efficiency range such that the end user is supplied with power through the second connection and such that any power generated in excess of the end user's demand is supplied to the grid through the first connection.

Related aspects of at least one embodiment provide a system, e.g., as described above, in which the controller is configured to maintain the generator at full load during on-peak hours.

Related aspects of at least one embodiment provide a system, e.g., as described above, in which the controller is configured to maintain the generator at or above 75% of its rated maximum efficiency during on-peak hours.

Related aspects of at least one embodiment provide a system, e.g., as described above, in which the controller is configured to maintain the generator at or above 80% of its rated maximum efficiency during on-peak hours.

Related aspects of at least one embodiment provide a system, e.g., as described above, in which the controller is configured to maintain the generator at or above 90% of its rated maximum efficiency during on-peak hours.

Related aspects of at least one embodiment provide a system, e.g., as described above, in which the generator comprises a conventional reciprocating engine generator.

Related aspects of at least one embodiment provide a system, e.g., as described above, in which the generator comprises a split-cycle engine generator.

Related aspects of at least one embodiment provide a system, e.g., as described above, in which the generator comprises a turbine engine generator.

Related aspects of at least one embodiment provide a system, e.g., as described above, in which the generator comprises a standalone expander engine generator.

In one aspect of at least one embodiment, a power generation method includes operating a generator within a high efficiency range to supply power generated by the generator to a power grid via a first connection between the generator and the power grid and to supply power generated by the generator to an end user via a second connection between the generator and the end user, such that any power generated in excess of a demand of the end user is supplied to the grid through the first connection.

Related aspects of at least one embodiment provide a method, e.g., as described above, that includes, during an on-peak period, operating the generator within the high efficiency range to supply power generated by the generator to the power grid via the first connection between the generator and the power grid and to supply power generated by the generator to the end user via the second connection between the generator and the end user, such that any power generated in excess of a demand of the end user is supplied to the grid through the first connection; and during an off-peak period, deactivating the generator such that the end user is supplied with power only through a third connection between the power grid and the end user through which grid power can be supplied to the end user.

Related aspects of at least one embodiment provide a method, e.g., as described above, in which said operating and deactivating steps are performed under the control of a digital data processing system coupled to the generator.

Related aspects of at least one embodiment provide a method, e.g., as described above, in which operating the generator comprises burning fuel to generate electrical output power.

Related aspects of at least one embodiment provide a method, e.g., as described above, in which operating the generator within the high efficiency range comprises maintaining the generator at full load.

Related aspects of at least one embodiment provide a method, e.g., as described above, in which operating the generator within the high efficiency range comprises maintaining the generator at or above 75% of its rated maximum efficiency.

Related aspects of at least one embodiment provide a method, e.g., as described above, in which operating the generator within the high efficiency range comprises maintaining the generator at or above 80% of its rated maximum efficiency.

Related aspects of at least one embodiment provide a method, e.g., as described above, in which operating the generator within the high efficiency range comprises maintaining the generator at or above 90% of its rated maximum efficiency.

In one aspect of at least one embodiment, a power system includes a generator configured to burn fuel and generate electrical power; a first connection between the generator and a power grid through which power generated by the generator can be supplied to the power grid; and a second connection between the generator and an end user through which power generated by the generator can be supplied to the end user; wherein the generator is operable at least in: a first operating mode in which the generator is maintained within a high efficiency operating range such that the end user is supplied with power through the second connection and such that at least a portion of any power generated in excess of the end user's demand is supplied to the grid through the first connection, and a second operating mode in which the generator is deactivated such that the end user is not supplied with power from the generator.

Related aspects of at least one embodiment provide a system, e.g., as described above, that includes a controller configured to selectively operate the generator in at least the first and second operating modes.

Related aspects of at least one embodiment provide a system, e.g., as described above, in which the controller is configured to operate the generator in the first operating mode during an on-peak period and to operate the generator in the second operating mode during an off-peak period.

Related aspects of at least one embodiment provide a system, e.g., as described above, in which the controller is configured to select between the first and second operating modes based on at least one of grid purchase price and end user demand.

Related aspects of at least one embodiment provide a system, e.g., as described above, in which the generator is maintained at full load in the first operating mode.

In one aspect of at least one embodiment, a method of operating a compressed air energy storage system includes, in an energy storage mode, using energy purchased from a power grid during a low-cost or off-peak period or energy supplied from a renewable energy source to turn a compressor to store compressed air in an air storage tank; and, in an energy conversion mode, combusting a mixture of fuel and compressed air supplied from the air storage tank in a generator to produce and supply electric power to the power grid during a high-cost or on-peak period; wherein the energy purchased from the power grid or supplied from the renewable energy source in the energy storage mode is less than the energy supplied to the power grid in the energy conversion mode.

Related aspects of at least one embodiment provide a method, e.g., as described above, in which the energy purchased from the power grid or supplied from the renewable energy source in the energy storage mode is equal to approximately one-half of the energy supplied to the power grid in the energy conversion mode.

Related aspects of at least one embodiment provide a method, e.g., as described above, in which the compressor comprises a split-cycle engine.

Related aspects of at least one embodiment provide a method, e.g., as described above, in which the generator comprises a split-cycle engine.

In one aspect of at least one embodiment, a method of operating a compressed air energy storage system includes, in an energy storage mode, using energy purchased from a power grid during a low-cost or off-peak period or energy supplied from a renewable energy source to turn a compressor to store compressed air in an air storage tank; and, in an energy conversion mode, combusting a mixture of fuel and compressed air supplied from the air storage tank in a generator to produce and supply electric power to an end user; wherein, in the energy conversion mode, the generator is operated at full-load and any electric power generated in excess of the demand of the end user is supplied to the power grid.

In one aspect of at least one embodiment, a method of operating a compressed air energy storage system includes, in an energy storage mode: using energy purchased from a power grid during a low-cost or off-peak period or energy supplied from a renewable energy source to turn a compressor to store compressed air in an air storage tank; and using a first heat exchanger to extract heat energy from the compressed air and store the heat energy in a heat storage system; and, in an energy conversion mode, combusting a mixture of fuel and compressed air supplied from the air storage tank in a generator to produce and supply electric power to an end user; and using a second heat exchanger to heat the compressed air supplied from the air storage tank using heat energy stored in the heat storage system.

Related aspects of at least one embodiment provide a method, e.g., as described above, in which the heat storage system comprises an insulated water tank.

Related aspects of at least one embodiment provide a method, e.g., as described above, that includes supplying heat energy from the heat storage system to satisfy a heat load of an end user.

Related aspects of at least one embodiment provide a method, e.g., as described above, that includes extracting waste heat energy from the generator and storing the extracted energy in the heat storage system.

In one aspect of at least one embodiment, a compressed air energy storage system includes a compressor having a crankshaft which is rotated by electrical power received from a power grid; an air storage tank coupled to the compressor and configured to store air compressed by the compressor therein; a generator configured to generate electrical power by mixing compressed air supplied from the air storage tank with fuel and combusting the mixture; a heat storage system configured to store thermal energy extracted from the air compressed by the compressor and waste heat generated as a result of combusting the mixture in the generator; wherein the system is operable in at least: an energy storage mode in which the electrical power received from the power grid drives the compressor to store compressed air in the air storage tank; a grid energy conversion mode in which compressed air stored in the air storage tank is supplied with the fuel to the generator and combusted to supply electric power to the power grid; an end user energy conversion mode in which compressed air stored in the air storage tank is supplied with the fuel to the generator and combusted to supply electric power to an end user; a feedback mode in which compressed air stored in the air storage tank is supplied with the fuel to the generator and combusted to supply electric power to the compressor; and a heat delivery mode in which thermal energy stored in the heat storage system is supplied to the end user to satisfy a heat load of the end user.

In one aspect of at least one embodiment, a power system includes a first generator configured to burn fuel and generate electrical power; a first connection between the generator and a power grid through which power generated by the generator can be supplied to the power grid; a second connection between the generator and an end user through which power generated by the generator can be supplied to the end user; a compressor having a crankshaft which is rotated by electrical power received from the power grid; an air storage tank coupled to the compressor and configured to store air compressed by the compressor therein; an air expander configured to expand compressed air supplied from the air storage tank to rotate an output shaft; a second generator operatively coupled to the output shaft of the expander and configured to generate electrical power; and a controller configured to operate the system in at least: a fuel-based generation mode in which the first generator is operated within a high efficiency range such that the end user is supplied with power through the second connection and such that any power generated in excess of the end user's demand is supplied to the grid through the first connection; a CAES energy storage mode in which the electrical power received from the power grid drives the compressor to store compressed air in the air storage tank; a CAES energy conversion mode in which compressed air stored in the air storage tank is supplied to the air expander and expanded to drive the second generator to supply electric power to the power grid.

Related aspects of at least one embodiment provide a system, e.g., as described above, in which the controller is configured to operate the system in the fuel-based generation mode and the CAES energy conversion mode simultaneously.

Related aspects of at least one embodiment provide a system, e.g., as described above, in which, during off-peak periods, the end user is supplied with power directly from the power grid and the controller operates the system only in the CAES energy storage mode.

Related aspects of at least one embodiment provide a system, e.g., as described above, in which, during on-peak periods, the controller operates the system in at least one of the CAES energy conversion mode and the fuel-based generation mode.

Related aspects of at least one embodiment provide a system, e.g., as described above, in which waste heat generated by the first generator when the system operates in the fuel-based generation mode is recovered and supplied to heat at least one of (a) compressed air stored in the air storage tank and (b) compressed air delivered to the air expander.

In one aspect of at least one embodiment, a power system includes a generator configured to burn fuel and generate electrical power; a first connection between the generator and a power grid through which power generated by the generator can be supplied to the power grid; a second connection between the generator and an end user through which power generated by the generator can be supplied to the end user; a compressor having a crankshaft which is rotated by electrical power received from the power grid; an air storage tank coupled to the compressor and configured to store air compressed by the compressor therein; an air expander configured to expand compressed air supplied from the air storage tank to rotate an output shaft, the output shaft being selectively coupled to a drive shaft of the generator; and a controller configured to operate the system in at least: a fuel-based generation mode in which the generator is operated within a high efficiency range such that the end user is supplied with power through the second connection and such that any power generated in excess of the end user's demand is supplied to the grid through the first connection; a CAES energy storage mode in which the electrical power received from the power grid drives the compressor to store compressed air in the air storage tank; a CAES energy conversion mode in which compressed air stored in the air storage tank is supplied to the air expander and expanded to drive the generator without added fuel to supply electric power to the power grid; and a hybrid generation and conversion mode in which compressed air stored in the air storage tank is supplied to the air expander and expanded to assist the generator as the generator operates on the fuel.

In one aspect of at least one embodiment, a power system includes a first generator configured to burn fuel and generate electrical power; a first connection between the generator and a power grid through which power generated by the generator can be supplied to the power grid; a compressor having a crankshaft which is rotated by electrical power received from the power grid; an air storage tank coupled to the compressor and configured to store air compressed by the compressor therein; an air expander configured to expand compressed air supplied from the air storage tank to rotate an output shaft; a second generator operatively coupled to the output shaft of the expander and configured to generate electrical power; a controller configured to operate the system in at least: a fuel-based generation mode in which the first generator is operated such that power generated by the generator is supplied to the grid through the first connection; a CAES energy storage mode in which the electrical power received from the power grid drives the compressor to store compressed air in the air storage tank; a CAES energy conversion mode in which compressed air stored in the air storage tank is supplied to the air expander and expanded to drive the second generator to supply electric power to the power grid; and wherein waste heat generated by the first generator when the system operates in the fuel-based generation mode is recovered and supplied to heat at least one of (a) compressed air stored in the tank and (b) compressed air delivered to the air expander.

Related aspects of at least one embodiment provide a system, e.g., as described above, that includes a second connection between the first generator and an end user through which power generated by the first generator can be supplied to the end user; and in which the controller is configured to operate the system in the fuel-based generation mode such that the end user is supplied with power through the second connection and such that any power generated in excess of the end user's demand is supplied to the grid through the first connection.

Related aspects of at least one embodiment provide a system, e.g., as described above, in which the air expander comprises a turbine.

Related aspects of at least one embodiment provide a system, e.g., as described above, in which the air expander comprises a combustion chamber in which fuel is added to compressed air supplied from the air storage tank and combusted.

Related aspects of at least one embodiment provide a system, e.g., as described above, in which waste heat generated by the air expander is recovered and supplied to heat at least one of (a) compressed air stored in the tank and (b) compressed air delivered to the air expander.

Related aspects of at least one embodiment provide a system, e.g., as described above, that includes a third connection between the first generator and the compressor through which power generated by the first generator can be delivered to drive the compressor.

Related aspects of at least one embodiment provide a system, e.g., as described above, that includes a fourth connection between the second generator and the compressor through which power generated by the second generator can be delivered to drive the compressor.

In one aspect of at least one embodiment, a power system includes a generator configured to burn fuel and generate electrical power; a first connection between the generator and a power grid through which power generated by the generator can be supplied to the power grid; a compressor having a crankshaft which is rotated by electrical power received from the power grid; an air storage tank coupled to the compressor and configured to store air compressed by the compressor therein; an air expander configured to expand compressed air supplied from the air storage tank to rotate an output shaft, the output shaft being operatively coupled to a drive shaft of the generator; and a controller configured to operate the system in at least: a fuel-based generation mode in which the generator is operated such that any power generated is supplied to the grid through the first connection; a CAES energy storage mode in which the electrical power received from the power grid drives the compressor to store compressed air in the air storage tank; and a CAES energy conversion mode in which compressed air stored in the air storage tank is supplied to the air expander and expanded to assist the generator as the generator operates on the fuel.

Related aspects of at least one embodiment provide a system, e.g., as described above, in which waste heat generated by the first generator when the system operates in the fuel-based generation mode is recovered and supplied to heat at least one of (a) compressed air stored in the tank and (b) compressed air delivered to the air expander.

Related aspects of at least one embodiment provide a system, e.g., as described above, that includes a second connection between the generator and an end user through which power generated by the generator can be supplied to the end user; and in which the controller is configured to operate the system in the fuel-based generation mode such that the end user is supplied with power through the second connection and such that any power generated in excess of the end user's demand is supplied to the grid through the first connection.

The present invention further provides methods, systems, and devices as claimed.

### BRIEF DESCRIPTION OF THE DRAWINGS

The invention will be more fully understood from the following detailed description taken in conjunction with the accompanying drawings, in which:

FIG. 1 is a schematic sectional view of a prior art split-cycle air hybrid engine;

FIG. 2 is a schematic sectional view of an air expander;

FIG. 3 is a schematic diagram of a first portion of a power system;

FIG. 4 is a schematic diagram of a second portion of the power system of FIG. 3;

FIG. 5 is a schematic diagram of the power system of FIGS. 3-4;

FIG. 6 is a schematic diagram of the power system of FIGS. 3-4 providing electrical power to an end user;

FIG. 7 is a schematic diagram of the power system of FIGS. 3-4 with an included heat recovery system;

FIG. 8 is a schematic diagram of the power system of FIG. 7 providing electrical power and heat to an end user;

FIG. 9 is a schematic diagram of a power system;

FIG. 10 illustrates a day-ahead pricing curve for grid electricity in the Connecticut region for Jul. 19, 2013;

FIG. 11 illustrates the curve of FIG. 10 with a dashed line overlay representing a time period during which the system of FIG. 9 is used;

FIG. 12 is a schematic diagram of a power system;

FIG. 13 is a schematic diagram of the power system of FIG. 12 using only a single generator;

FIG. 14 is a schematic diagram of the power system of FIG. 12 with an end user output omitted;

FIG. 15 is a schematic diagram of the power system of FIG. 14 using only a single generator;

FIG. 16 is a schematic diagram of the power system of FIG. 12 with a turbine expander;

FIG. 17 is a schematic diagram of the power system of FIG. 12 with waste heat recovery from an engine-generator and from an expander-generator;

FIG. 18 is a schematic diagram of the power system of FIG. 12 with an electrical coupling between an engine-generator output and a motor-compressor input; and

FIG. 19 is a schematic diagram of the power system of FIG. 12 with an electrical coupling between an expander-generator output and a motor-compressor input.

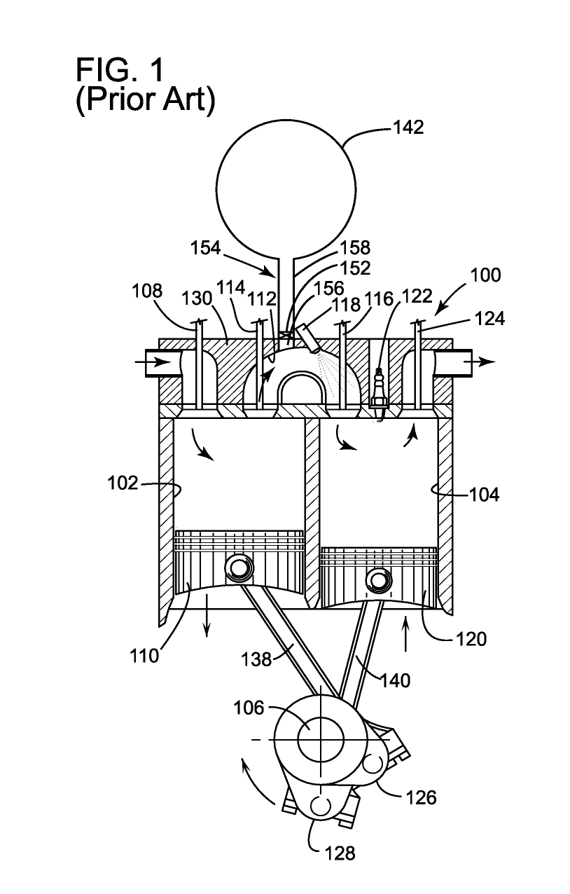

### DETAILED DESCRIPTION

A number of exemplary power generation systems and methods are disclosed herein. In some embodiments, a compressed air energy storage system, optionally with split-cycle engine technology, is used to store energy obtained from the grid during off-peak hours and to supply stored energy to the grid and/or to an end user during on-peak hours. The system can include heat recovery features and can supply heat to the end user. In other embodiments, a generator system is used to provide power to an end user and to the grid. The generator can be maintained in a high efficiency operating range (e.g., at elevated or full load), even when the generator output exceeds the end user's demand, with any excess generated power being fed to the grid.

Certain exemplary embodiments will now be described to provide an overall understanding of the principles of the structure, function, manufacture, and use of the methods, systems, and devices disclosed herein. One or more examples of these embodiments are illustrated in the accompanying drawings. Those skilled in the art will understand that the methods, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The cost of purchasing electrical power from a grid fluctuates over time as demand for power changes. For example, it is often less expensive to purchase electrical power from the grid at night, when demand is reduced. In addition, the output power level of many renewable energy sources (such as solar, hydroelectric, or wind power) fluctuates based on weather conditions and other factors. A system which is capable of storing energy can smooth these fluctuations, for example by purchasing and storing energy at night when it is less expensive and then supplying the energy to a load during the day when demanded, or by storing excess energy generated by renewable sources when weather conditions are favorable and then supplying the energy to a load when the weather conditions are less favorable. It is also possible to purchase power from the grid at low cost during off-peak hours, store the power for some period of time, and then sell the power back to the grid for a profit during on-peak hours.

In an exemplary system, power is purchased from the grid during periods of low demand or at any other time that energy costs are low. The purchased power is stored in an array of electrochemical batteries and then sold back to the grid later for a higher price. There are a number of drawbacks associated with this system. First, batteries are expensive which drives up the equipment cost of the system. Second, batteries often include materials which are difficult or expensive to dispose of in an environmentally-friendly way once the battery's useful life has expired. Third, the storage efficiency of a battery is less than 100% (usually approximately 80%) and therefore some of the purchased energy is lost in the storage process and cannot be supplied back to the grid. CAES systems, and in particular CAES systems that employ split-cycle engine technology, provide a more cost-effective solution and eliminate or reduce many of these disadvantages. Such systems also provide a number of other advantages, as discussed in more detail below.

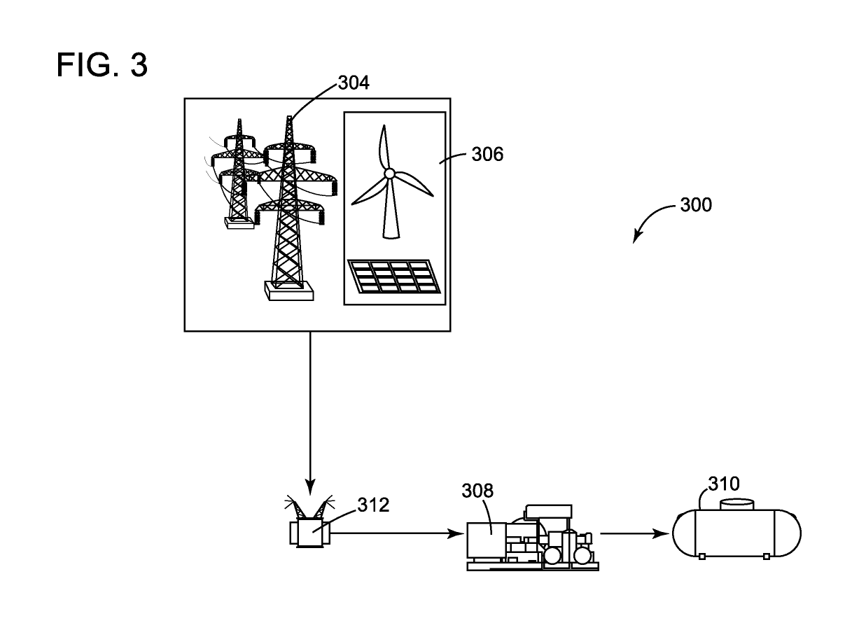

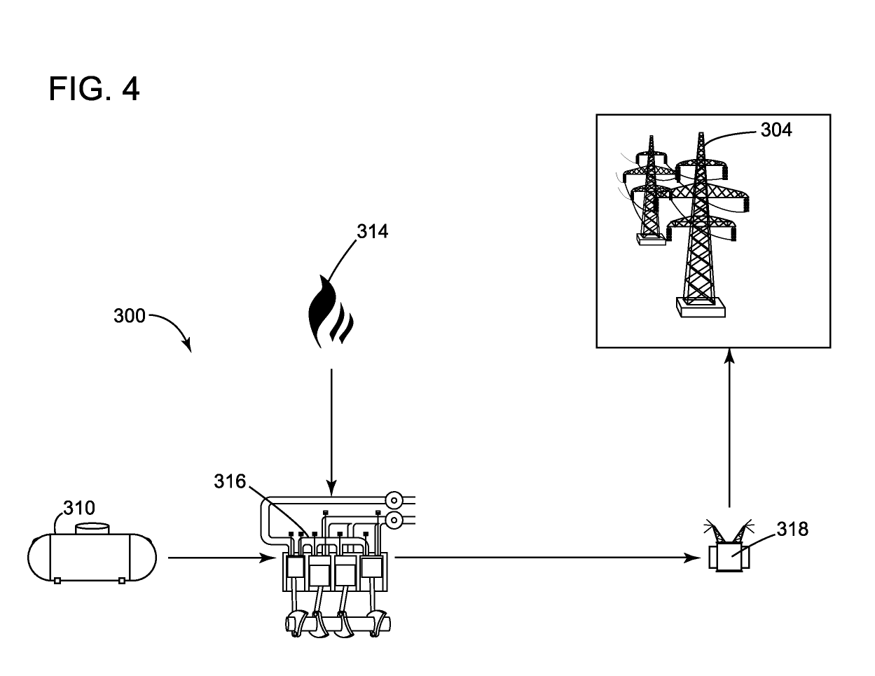

FIGS. 3-4 illustrate an exemplary embodiment of a CAES system 300. As shown in FIG. 3, during off-peak periods, power is purchased at low cost from the grid 304. Power can also be provided from renewable energy sources 306. The input power to the system is used to drive an air compressor system 308 (e.g., the compressor side of an air hybrid split-cycle engine) to compress air into one or more tanks 310 for storage. In some embodiments, the compressor system includes an electric motor that rotates a crankshaft to which a compression piston is coupled. The input power can optionally be conditioned in any of various ways, such as by down-converting the voltage through a transformer 312. As shown in FIG. 4, during on-peak periods, high pressure air stored in the tanks is supplied along with fuel 314 (e.g., fossil fuels, gasoline, natural gas, biogas, biodiesel, diesel, ethanol, LNG, etc.) to a generator system 316 (e.g., the expander side of an air hybrid split-cycle engine) where they are mixed and combusted to produce electrical power which can be sold back to the grid 304 at peak demand. The output of the generator system 316 can be coupled to the grid 304 via an optional transformer 318.

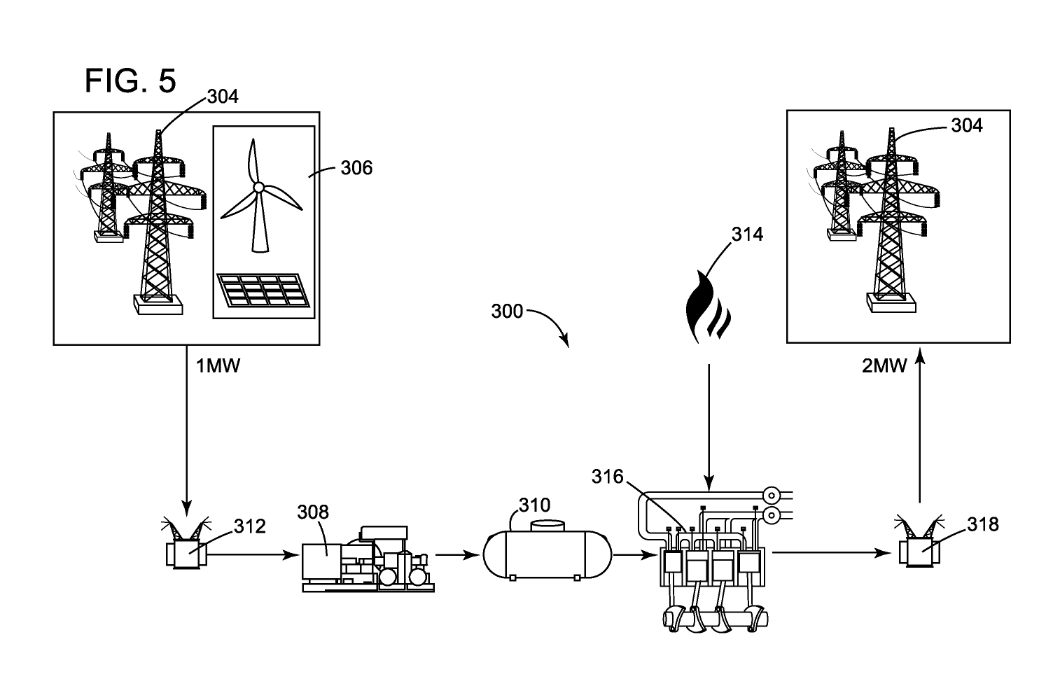

FIG. 5 is an energy flow diagram for the system 300 of FIGS. 3-4. As shown, the system 300 in this exemplary embodiment is configured to deliver two times more energy to the grid 304 (e.g., about 2 MW) than what it draws from the grid 304 or from renewable sources 306 (e.g., about 1 MW). The energy required to make up for this differential and any efficiency losses is provided by the fuel 314. In this exemplary system, the grid 304 can be the primary customer of the system 300.

A comparison of costs and efficiency for the illustrated 2 megawatt (MW) CAES system and a comparable battery-based system is provided below. It will be appreciated that the following discussion is non-limiting and merely exemplary. The electrical consumption of the exemplary 2 MW CAES system from the grid or renewable sources is 1 MW. Assuming the comparable battery system has an 80% storage/recovery efficiency, its electrical consumption for 2 MW of output power is 2.5 MW. The fuel consumption of the CAES system is the amount required to compensate for the difference between electrical consumption and electrical output (1 MW in this example) and any efficiency losses of the system. The fuel consumption of the comparable battery system is zero. The equipment cost of the CAES system is significantly less than that of the battery system, as batteries are much more expensive than compressors, generators, and air tanks (e.g., 5-10 times more expensive). In the end, the cost of the fuel consumption associated with the CAES system is typically much less than the added equipment cost and electrical consumption/efficiency cost of the battery system, making the CAES system a more attractive option. As the systems are scaled, the difference in equipment costs grows significantly, with the battery equipment costing far more than the CAES equipment. The value proposition for the CAES system over the battery system thus increases as the system output is made larger.

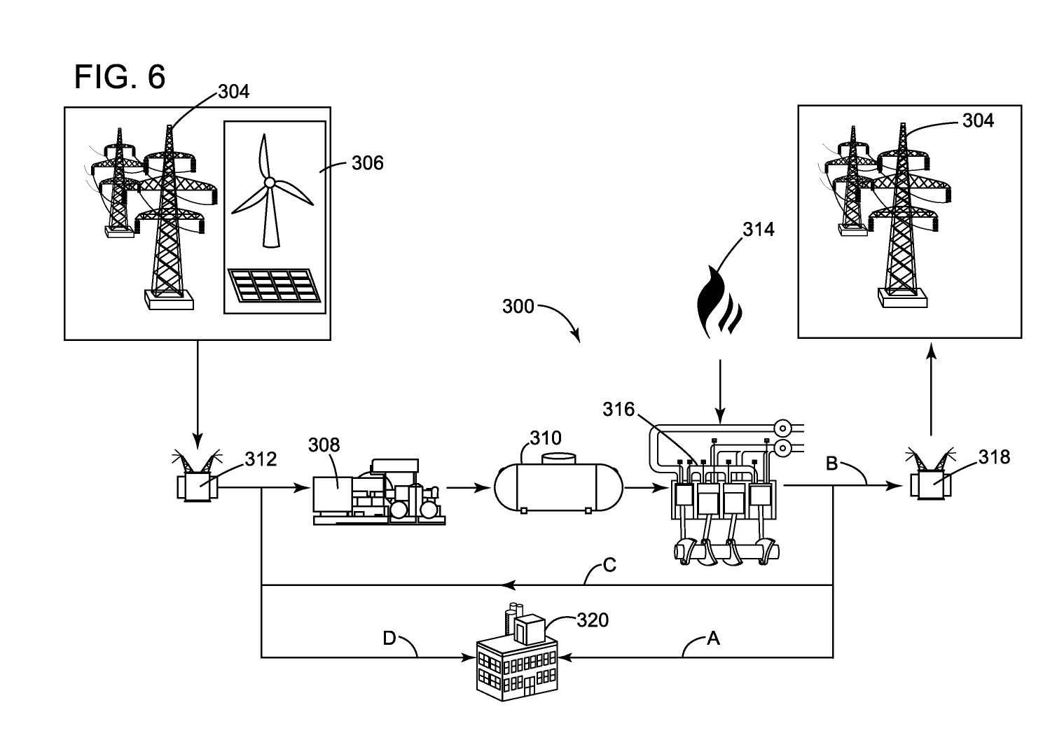

As shown in FIG. 6, power output from the system 300 can also be supplied to an end user 320 through a path (A). The system is thus capable of providing a backup for the user in the event that there is a grid power failure or period of low renewable output. The system is easily scalable (e.g., by simply adding more storage tanks or compressor/generator capacity) and can therefore grow with the end user. The system also provides low cost electricity to the end user. In some embodiments, the system 300 is sized to have a peak power production capacity that is equal to or greater than the peak demand of the end user 320. Any excess power generated when the user demand is below the peak, or any excess power generated in the case of an oversized system, is sold back to the grid through a path (B) while simultaneously supplying power to the end user 320 through path (A). Alternatively, or in addition, at least a portion of the excess power can be fed through a path (C) back to the input of the compressor system 308. The system 300 can thus be configured to use excess generated power to compress additional air into the storage tanks 310, for example when the grid 304 is down due to an outage and it is not possible to sell power back to the grid. The connection path (C) also allows the system 300 to continue running even when the compressor side 308 of the system is unable to draw power from the grid 304 or from renewable sources 306. In such cases, the generator 316 uses the fuel supply 314 to continue supplying power to the end user 320. A portion of the power generated is provided to meet end user demand while the remaining portion is fed back to the compressor 308 to generate compressed air for use in the generator's air hybrid operation.

The ability to sell power back to the grid 304, even when the end user 320 is running at part load, or to feed excess power back to drive the compressor side 308 of the system, allows the generator 316 (e.g., an air hybrid split-cycle engine operating in AEF mode) to run continuously at elevated load or at full load, which is generally more efficient than low-load operating conditions. Thus, the system is able to maintain operation at peak efficiency even when the end user demand is low, as any excess power is simply sold back to the grid or used to compress more air into the storage tanks.

As also shown in FIG. 6, the end user 320 can be supplied directly from the grid 304 or the renewable sources 306 via a path (D), bypassing the CAES system 300. This allows the end user 320 to purchase power directly from the grid 304 (e.g., during off-peak hours when the cost is low) or to receive power directly from the renewable sources 306.

In the arrangement shown in FIG. 6, the end user 320 becomes a secondary customer of the system 300, which can provide the end user with low cost electricity and heat. The system 300 can also act as a backup system to provide power to the end user 320 during grid 304 or renewable 306 outages. The system 300 can also easily grow with the end user 320 as the end user's demand changes.

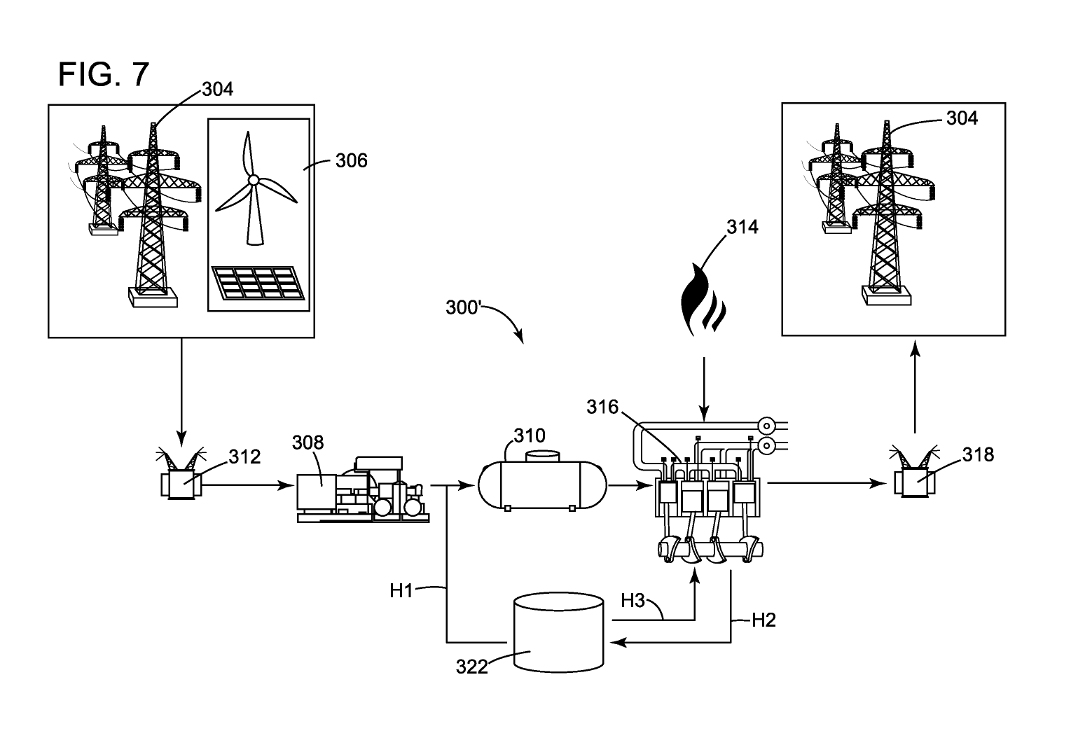

FIG. 7 illustrates an exemplary embodiment of a CAES system 300′ with waste heat recovery, which can serve as a combined heat and power (CHP) system. Except as described below, the structure and operation of the system 300′ is substantially similar to that of the system 300 described above, and therefore a detailed description is omitted here for the sake of brevity. As shown, in the system 300′, input power is provided from renewable energy sources 306 or purchased at low cost from the grid 304 during off-peak periods. The power is used to drive an air compressor system 308 (e.g., the compressor side of an air hybrid split-cycle engine) to compress air into one or more tanks 310 for storage. During on-peak periods, air stored in the tanks 310 is supplied along with fuel 314 (e.g., fossil fuels, gasoline, natural gas, biogas, biodiesel, diesel, ethanol, LNG, etc.) to a generator system 316 (e.g., the expander side of an air hybrid split-cycle engine or a standalone expander) where they are mixed and combusted to produce electrical power which can be sold back to the grid 304 at peak demand.

As air compressed by the compressor system 308 is delivered to the tanks 310 for storage, heat generated during the compression process is extracted from the air using a heat exchanger (e.g., an air-to-water heat exchanger). The heated water or other media used to extract heat from the compressed air is stored in a heat storage system 322 via a path (H1). Exemplary heat storage systems include insulated water tanks, rock bed heat storage systems, or any other systems with high thermal mass. By cooling the compressed air, the density of the air in the air tank 310 can be increased to increase the stored mass of air, and the work required to push the air into the air tank by the compressor 308 can be reduced as the tank pressure will be lower for a given mass of contained air than would be the case with uncooled air.

A heat exchanger can also be used to recover waste heat from the generator side 316 of the system. The heat exchanger extracts heat from hot exhaust gasses exiting the generator 316 and supplies the heat (e.g., via heated fluid circulated through the heat exchanger) via a path (H2) to the heat storage system 322. Heat of combustion dissipated through the engine block of the generator 316 and/or through the generator's cooling system is recovered in a similar fashion to supply additional thermal energy to the heat storage system 322.

Thermal energy stored in the heat storage system 322 can be used subsequently to heat compressed air via a path (H3) as the air is transferred from the storage tanks 310 to the generator 316. Heating the air is effective to increase the energy of the air before expanding and combusting it in the generator 316. Heating the air charge also helps maintain expansion cylinder pressure and helps maintain sonic flow into the expansion chamber of the generator 316.

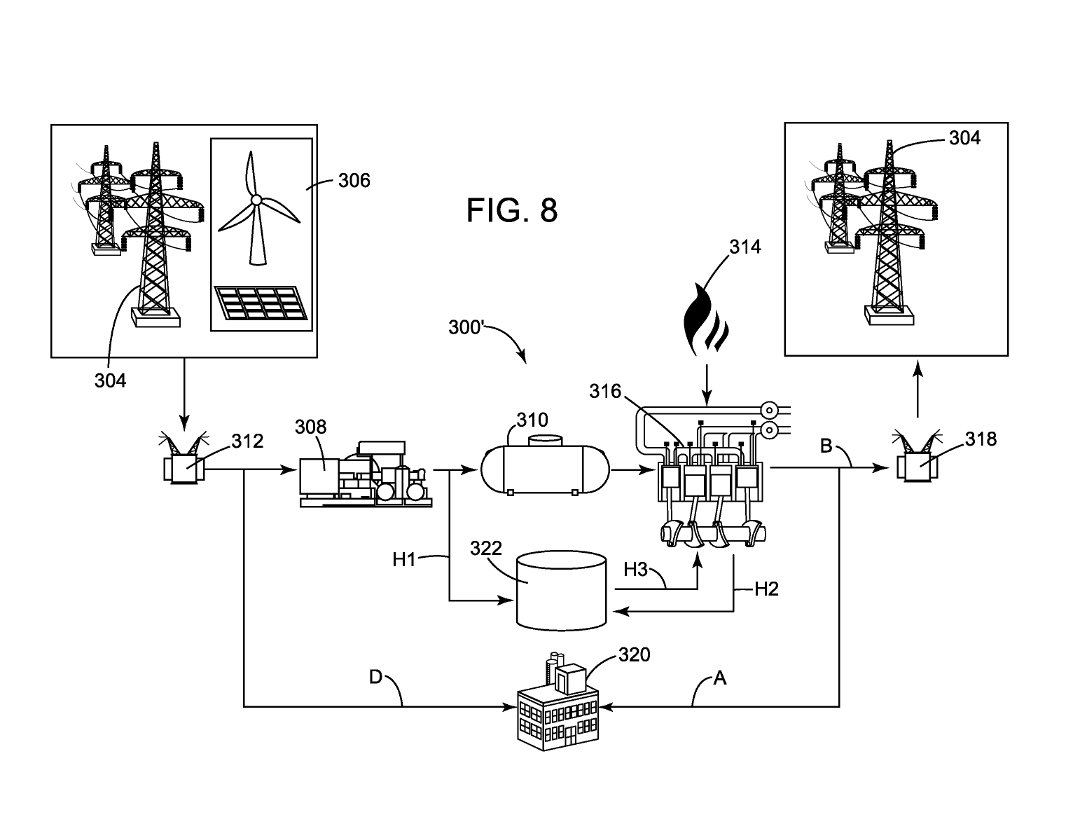

As shown in FIG. 8, thermal energy stored in the heat storage system 322 can also be supplied to an end user 320 via a path (H4) to meet some or all of the end user's heat load (e.g., for heating conditioned spaces of buildings, supplying heated domestic hot water, or supporting industrial or commercial processes that require thermal energy). In some embodiments, the heat storage system 322 is used to supply the entirety of the end user's heat load, with any excess heat being used to pre-heat air supplied to the generator 316 from the air storage tanks 310. Off-peak power can be supplied to the end user 320 from the grid 304 or renewable sources 306 via a path (D). Peak power can be supplied to the end user 320 from the output of the generator 316 via a path (A). The generator 316 output can also be supplied to the grid 304 via a path (B) and/or back to the compressor 308 via a path (C) (not shown in FIG. 8, see FIG. 6) as described above.

The above system advantageously allows for self regulation of both the electrical power output and the heat energy output. In particular, any excess electrical power output beyond the end user's electrical load is sold back to the grid 304 via the path (B) or fed back to support compression via the path (C) (see FIG. 6). Any excess heat energy output beyond the end user's heat load is fed back via the path (H3) to support generation. This allows the system to be sized to meet both the peak heat load and the peak electrical power load of the end user 320. In other words, even if the system is oversized for one or both of the heat requirement and the electrical power requirement, the system can still be run at high load or full load to maximize efficiency, with any excess output being captured and used beneficially. This is in contrast with existing CHP systems, which must typically be sized based on the end user's peak heat load at the expense of inadequate electrical power output capacity for the user's requirements.

Additional details on waste heat recovery are disclosed in U.S. Publication No. 2012/0255296 filed on Apr. 6, 2012 and entitled “AIR MANAGEMENT SYSTEM FOR AIR HYBRID ENGINE” and in U.S. Pat. No. 7,571,699 issued on Aug. 11, 2009 and entitled “SYSTEM AND METHOD FOR SPLIT-CYCLE ENGINE WASTE HEAT RECOVERY” each of which is hereby incorporated by reference herein in its entirety.

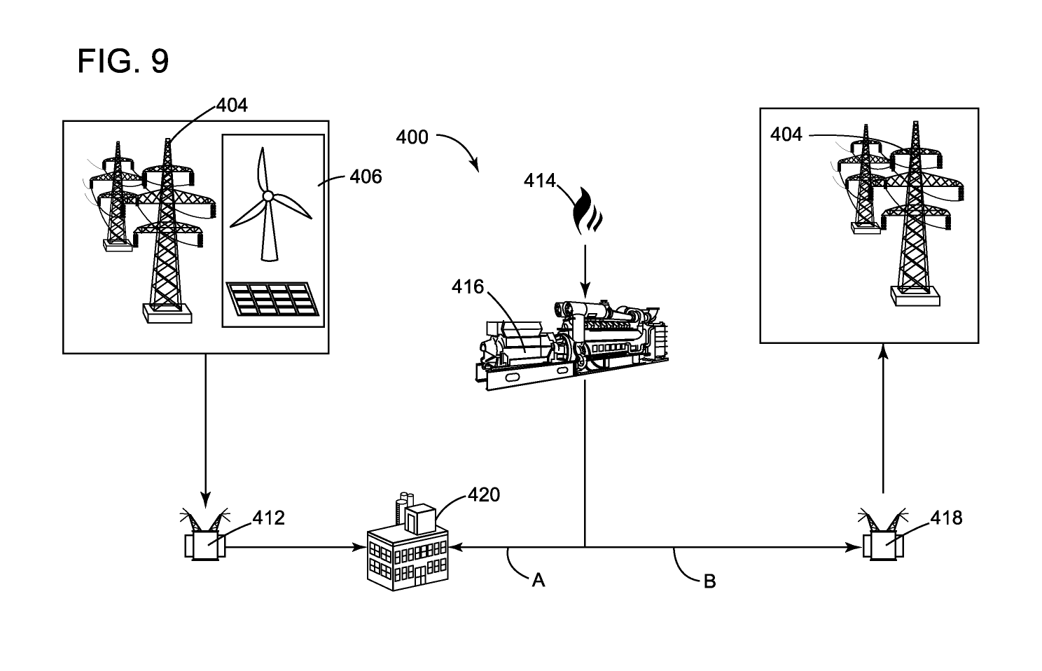

FIG. 9 illustrates another exemplary embodiment of a power system 400. The power system 400 can include any of the features of the systems described above though, in some embodiments, the power system can employ only a conventional generator or generators, in which case some of the features described above which require a non-conventional generator may not be applicable. As used herein, a conventional generator is a generator that is mechanically driven by a conventional engine as described above, or by a turbine engine such as a steam turbine or a combustion turbine. In the illustrated system 400, the end user 420 purchases power from the grid 404 during off-peak hours when power costs are low. The user can also receive power from renewable sources 406. A transformer 412 or other conditioning circuitry can optionally be included between the end user 420 and the grid 404 or renewable sources 406. During on peak hours when power costs increase, the end user 420 is supplied with electrical power by a generator 416 which is powered by fuel 414. As noted above, in some embodiments, the generator 416 is a conventional generator. The generator output is coupled both to the end user 420 (e.g., via a path (A)) and to the power grid 404 (e.g., via a path (B)). A transformer 418 or other conditioning circuitry can optionally be included between the generator 416 and the grid 404. Since the generator 416 is coupled both to the end user 420 and to the grid 404, the generator 416 can be maintained in a high efficiency operating range (e.g., at elevated or full load), even when the generator output exceeds the end user's demand. In some embodiments, the high efficiency operating range is a range of operating loads at which the generator operates at or above 75% of its rated maximum efficiency, and more preferably at or above 80% of its rated maximum efficiency, and more preferably at or above 90% of its rated maximum efficiency. Any excess power generated during such periods can be sold back to the grid 404 through the illustrated path (B). The illustrated system is more efficient than a traditional generator that simply follows the end user's demand, since the generator can be maintained in a maximum efficiency operating range. It will be appreciated that the illustrated system need not necessarily include CAES capability. Rather, the generator can be a conventional reciprocating engine generator, a split-cycle engine generator, a turbine engine generator, etc.

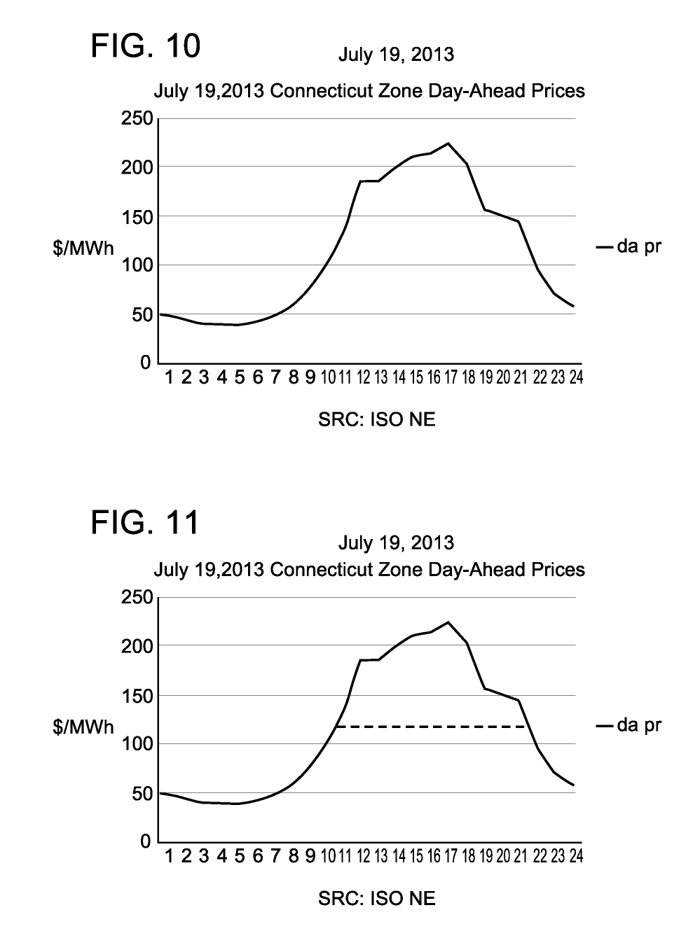

FIG. 10 illustrates a day-ahead pricing curve for grid electricity in the Connecticut region for Jul. 19, 2013. As shown, the cost of purchasing electricity from the grid increases significantly during on-peak daytime hours. FIG. 11 illustrates the same curve with a dashed line overlay representing a time period during which the generator of FIG. 9 is active. As shown, the end user can purchase electricity from the grid between midnight and 10:00 am, when the price is low (e.g., less than about $120 per megawatt-hour). Between 10:00 am and 10:00 pm, instead of purchasing power from the grid at the higher, on-peak price, the end user can be supplied with power by the generator of FIG. 9. As shown by the dashed line, the generator can supply power to the user at a cost (e.g., about $120 per megawatt-hour) which is less than the on-peak grid price, thus providing significant cost savings to the end user. Between 10:00 pm and midnight, the end user can again purchase power from the grid at the reduced, off-peak price. During the time period when the generator is active, the generator is operated at maximum efficiency, with power generated in excess of the user's demand being sold back to the grid. It will be appreciated that the illustrated generator cost and switchover thresholds are merely exemplary. The system can include a digital data processing system or controller configured to monitor the grid purchase price, end user demand, and/or various other factors and to make a determination based on said factors as to when to turn the generator on and off.

The system of FIG. 9 can thus utilize the grid to regulate and maintain the output of the generator within a maximum efficiency load range regardless of how the end user's load is fluctuating. In this system, the output of the generator is connected in parallel to both the grid and the end user and the generator feeds power to both. As the end user's load requirements vary, the generator's output can be kept within a relatively constant high efficiency load range by increasing or decreasing power to the grid accordingly. In contrast, a generator that must follow the load of an end user can lose as much as half of its efficiency as the end user's load drops from peak to low load. By maintaining the output of the generator at or near full load with the grid, the generator's efficiency also remains at or near full efficiency.

Similar to the system illustrated in FIG. 9, the CAES system of FIG. 8 is also connected in parallel to both the end user and the grid to maintain the generator's output within a relatively constant high efficiency range. However, the CAES system has the added advantages of: (1) having CAES capability, wherein it is able to store and retrieve energy from the grid as compressed air in its air tanks; (2) the expander-generator having a potentially higher power density then a conventional generator; and (3) the expander-generator having a theoretical higher efficiency than a conventional generator.

The CAES capability enables the CAES system to store electric power from the grid (or a renewable resource, such as wind, hydro or solar power) at a low cost during off-peak hours and to provide that stored energy back to the end user or grid during peak hours at a reduced cost. The higher power density enables the expander-generator to generate the same amount of power as a similarly rated conventional generator, but in a much smaller package size and a much smaller manufacturing cost. The efficiency of the expander-generator is potentially between 60 to 70 percent when generating power from the stored energy in the air tanks, making the overall efficiency of the CAES system potentially greater than the efficiency of a conventional generator system.

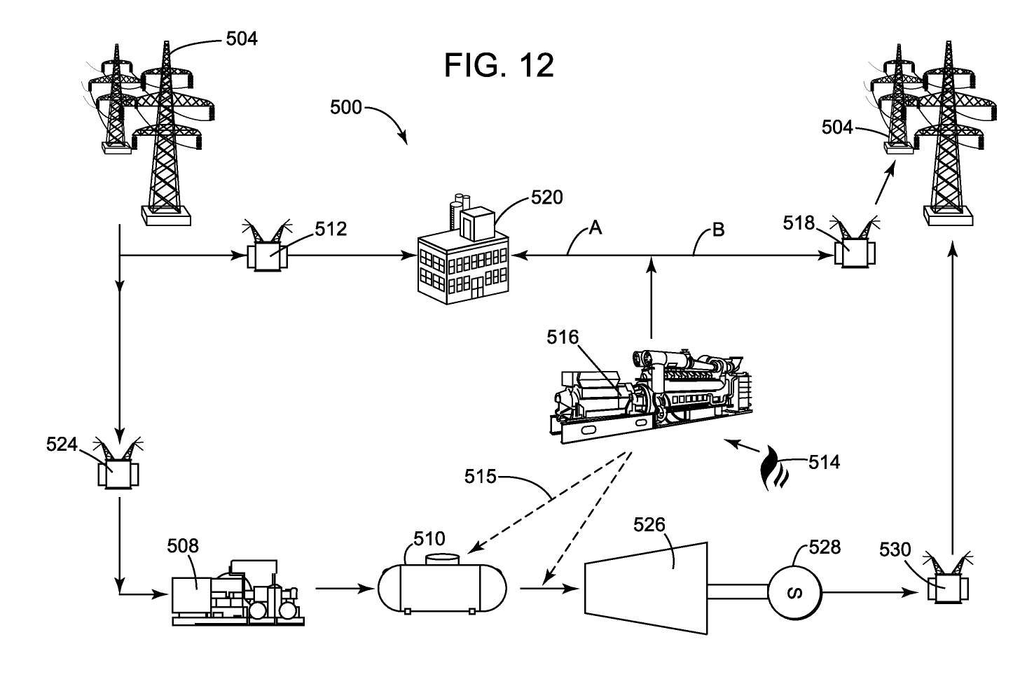

FIG. 12 illustrates an exemplary embodiment of a CAES system 500. The system 500 includes a first portion through which an end user 520 can be supplied with power in an efficient manner by operating a generator 516 in a high efficiency operating range and selling excess generated power to the grid 504. Input power from the grid 504 and/or from renewable energy sources (not shown) can be supplied to an end user 520. The input power can optionally be conditioned in any of various ways, such as by down-converting the voltage through a transformer 512. In an exemplary mode of operation, the end user 520 purchases power from the grid 504 during off-peak hours when power costs are low. The user can also receive power from renewable sources (not shown).

During on-peak hours when power costs increase, the end user 520 is supplied with electrical power by the generator 516, which is powered by fuel 514. In some embodiments, the generator 516 is a conventional generator. The generator output is coupled both to the end user 520 (e.g., via a path (A)) and to the power grid 504 (e.g., via a path (B)). A transformer 518 or other conditioning circuitry can optionally be included between the generator 516 and the grid 504. Since the generator 516 is coupled both to the end user 520 and to the grid 504, the generator 516 can be maintained in a high efficiency operating range (e.g., at elevated or full load), even when the generator output exceeds the end user's demand. In some embodiments, the high efficiency operating range is a range of operating loads at which the generator operates at or above 75% of its rated maximum efficiency, and more preferably at or above 80% of its rated maximum efficiency, and more preferably at or above 90% of its rated maximum efficiency. Any excess power generated during such periods can be sold back to the grid 504 through the illustrated path (B). The illustrated system is more efficient than a traditional generator that simply follows the end user's demand, since the generator can be maintained in a maximum efficiency operating range. The generator can be a conventional reciprocating engine generator, a split-cycle engine generator, a turbine engine generator, etc.

The system 500 also includes a second portion through which a CAES function can be performed. Input power from the grid 504 and/or from renewable energy sources (not shown) can be supplied to an air compressor system 508 (e.g., a motor-compressor). The input power can optionally be conditioned in any of various ways, such as by down-converting the voltage through a transformer 524. The power supplied to the air compressor system 508 drives the compressor to compress air into one or more tanks 510 for storage.

In an exemplary mode of operation, during off-peak periods, power is purchased at low cost from the grid 504 and used to drive the compressor 508 to store compressed air in the tanks 510. Power can also be provided from renewable energy sources (not shown). During on-peak periods, high pressure air stored in the tanks 510 is supplied to an air expander 526. The air expander is operatively-coupled to a generator system 528. For example, compressed air can be expanded in the air expander 526 to rotate an output shaft of the expander, the output shaft being coupled to the input shaft of a generator 528. Rotation of the generator 528 produces electrical power which can be supplied to the end user 520 and/or sold back to the grid 504 at peak demand. The output of the generator system 528 can be coupled to the grid 504 via an optional transformer 530.

As indicated by the dotted lines in FIG. 12, waste heat produced by the generator 516 as a byproduct of burning fuel 514 can be recovered and used to heat compressed air used in the CAES portion of the system. For example, the recovered heat can be used to heat the air tanks 510, or can be used to heat the air on-demand, as the air is supplied to the air expander 526. Heat exchangers or various other similar devices can be used to recover heat energy from the generator 516 and supply it to the compressed air. Pre-heating the air can advantageously increase the efficiency and output power of the expander 526.

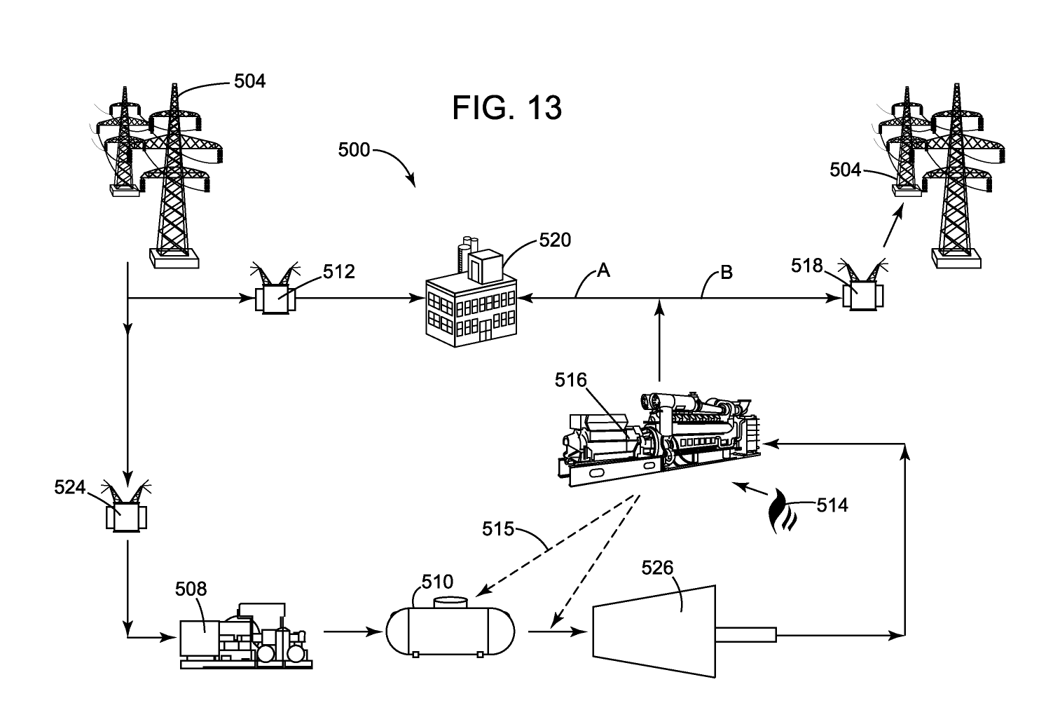

As shown in FIG. 13, the generator 528 can optionally be omitted, with the output shaft of the air expander 526 instead being operatively coupled to the same generator 516 used in the first portion of the system. In other words, the system can use only a single generator 516 as compared to the plural generators used in the system of FIG. 12. A clutch or other mechanism can be coupled between the output shaft of the air expander 526 and the crankshaft of the generator 516 to facilitate selective decoupling of said components. The air expander 526 can be decoupled from the generator 516 when the CAES side of the system is in a compressed air storage mode and the air expander is inactive. The air expander 526 can be coupled to the generator 516 when the CAES side of the system is in a compressed air energy recovery mode and can thus be used to drive the generator. The generator 516 can be driven exclusively by the air expander 526 without burning fuel 514, or can be driven simultaneously by burning fuel and by the air expander. The air expander 526 can thus perform a power-assist function, improving the efficiency and output of the generator 516 as compared with the generator operating exclusively on the fuel 514.

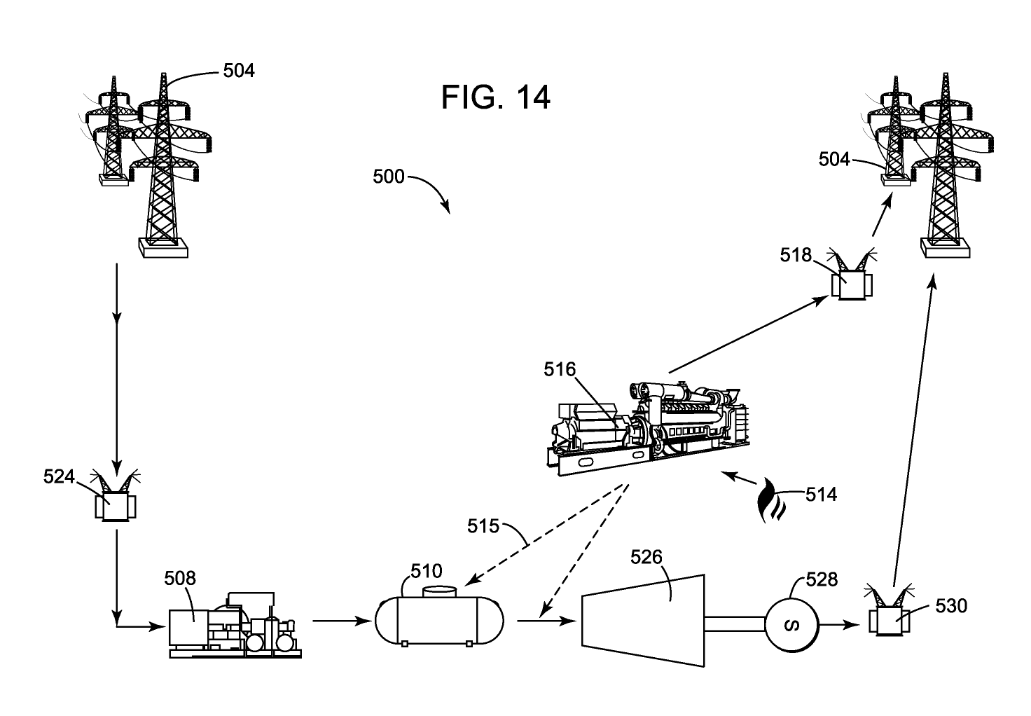

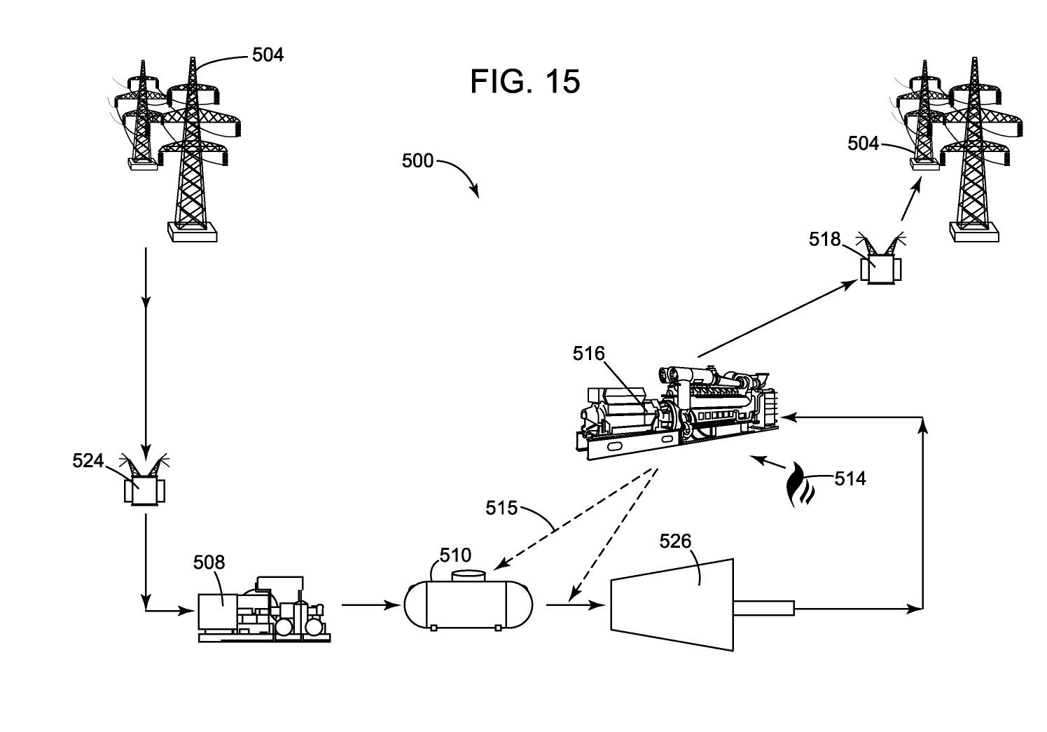

As shown in FIGS. 14 and 15, the systems of FIGS. 12 and 13, respectively, can be configured such that the second output from the generator 516 to the end user is omitted. Thus, in some embodiments, substantially the entirety of the generator's output is delivered to the grid.

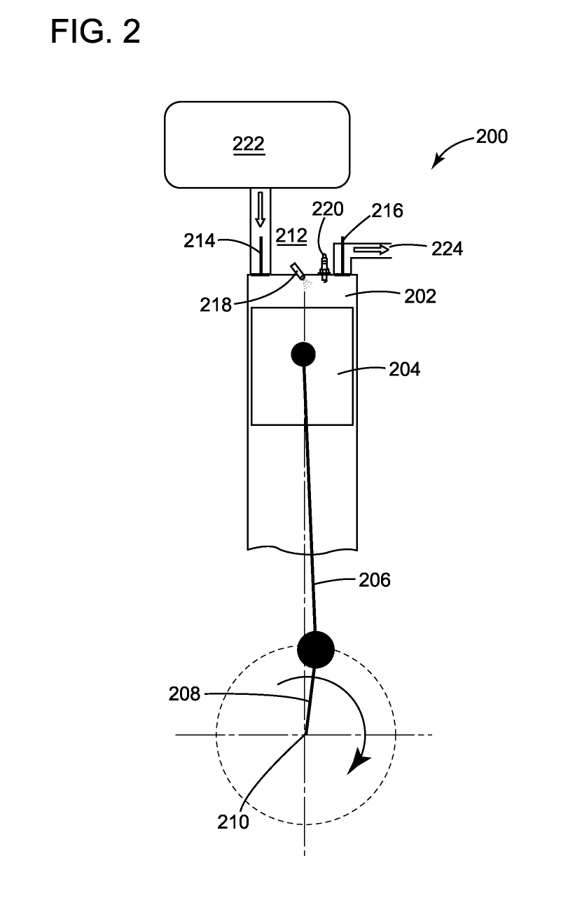

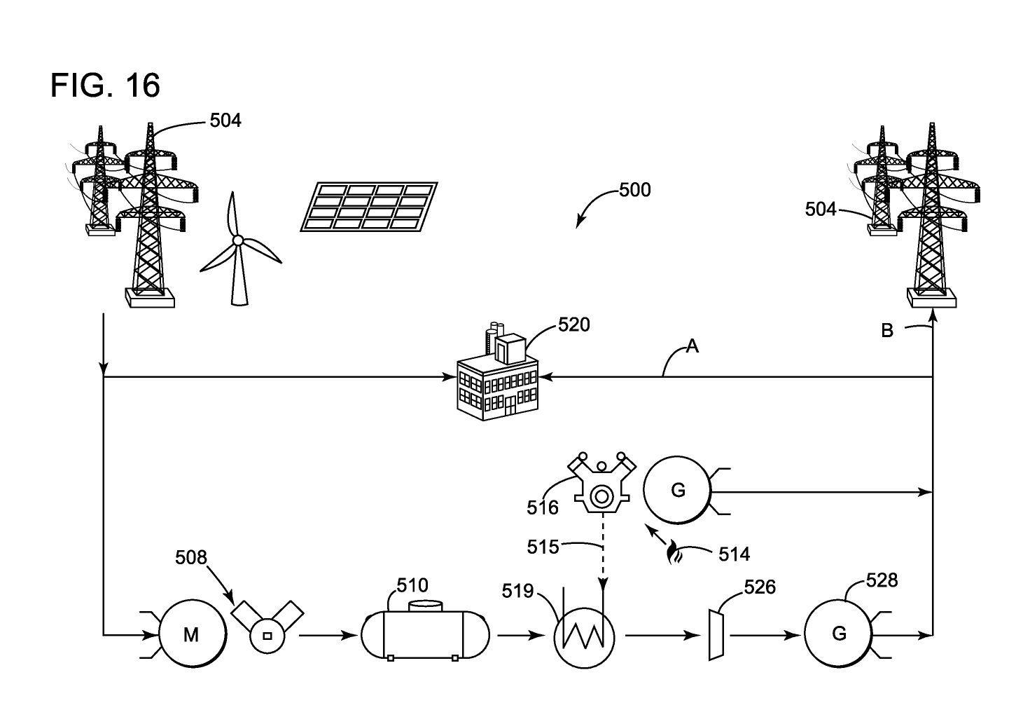

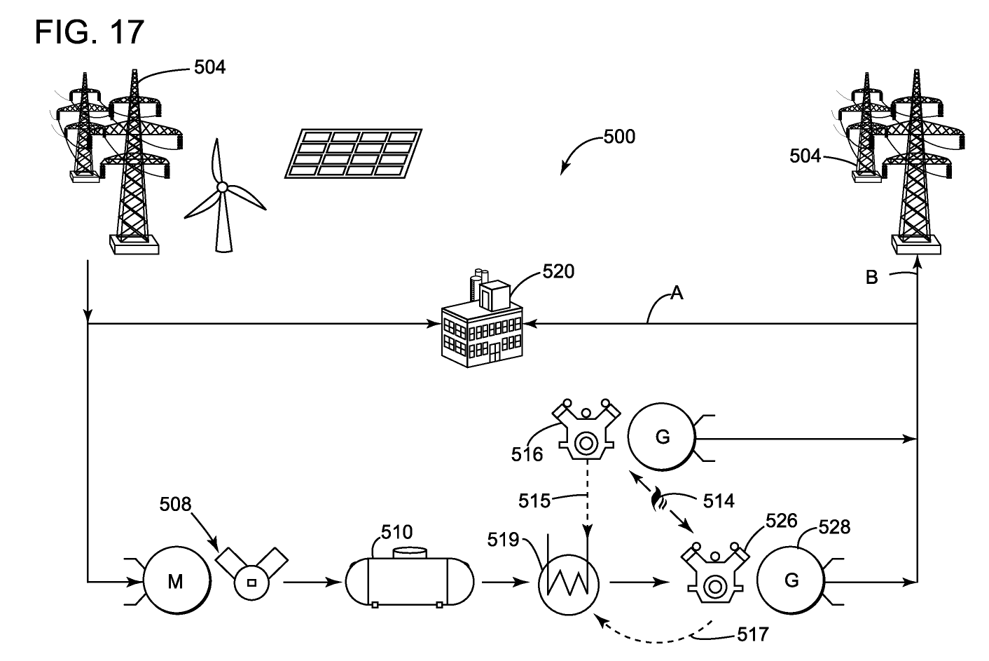

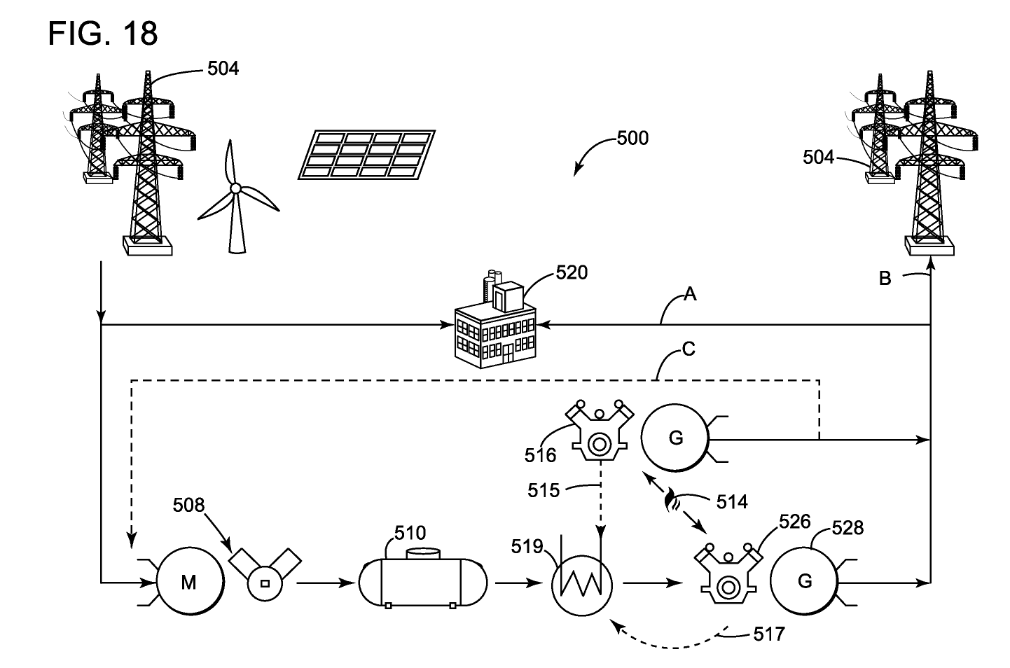

The expander 526 can be or can include various devices. For example, as shown in FIG. 16, the expander 526 can be or can include a turbine configured to rotate an output shaft as compressed air is expanded therein. The output shaft of the turbine can be coupled to the generator 528 to rotate the generator and produce electrical power. By way of further example, as shown in FIG. 17, the expander 526 can be or can include a standalone expander of the type shown in FIG. 2. In other embodiments, the expander 526 can be or can include a split-cycle engine.

As also shown in FIG. 17, waste heat produced by the expander 526 as a byproduct of burning fuel 514 can be recovered and used to heat compressed air used in the CAES portion of the system. For example, the recovered heat can be used to heat the air tanks 510, or can be used to heat the air on-demand, as the air is supplied to the air expander 526. Heat exchangers or various other similar devices can be used to recover heat energy from the expander 526 and supply it to the compressed air. The heat exchanger extracts heat from hot exhaust gasses exiting the expander 526 and supplies the heat (e.g., via heated fluid circulated through the heat exchanger) to the air input to the expander. Heat of combustion dissipated through the engine block of the expander 526 and/or through the expander's cooling system can be recovered in a similar fashion to supply additional thermal energy to the expander input. The air supplied to the expander 526 can be pre-heated using waste heat from the expander 526, waste heat from the generator 516, and/or a combination thereof, either simultaneously, sequentially, or otherwise. Utilization of waste heat to pre-heat the air input to the expander 526 can advantageously improve the efficiency of the expander. In some embodiments, the efficiency gain can be between about 10% and about 15%.

As shown in FIG. 18, the system 500 can include an electrical coupling (C) between the output of the engine-generator 516 and the input of the motor-compressor 508. Accordingly, at least a portion of any excess power generated by the engine-generator 516 can be fed back to the input of the motor-compressor system 508. The system 500 can thus be configured to use excess generated power to compress additional air into the storage tanks 510, for example when the grid 504 is down due to an outage and it is not possible to sell power back to the grid. The connection path (C) also allows the system 500 to continue running even when the compressor side 508 of the system is unable to draw power from the grid 504 or from renewable sources 506. In such cases, the generator 516 uses the fuel supply 514 to continue supplying power to the end user 520. A portion of the power generated is provided to meet end user demand while the remaining portion is fed back to the compressor 508 to generate compressed air for use in air hybrid operation of the expander 526.

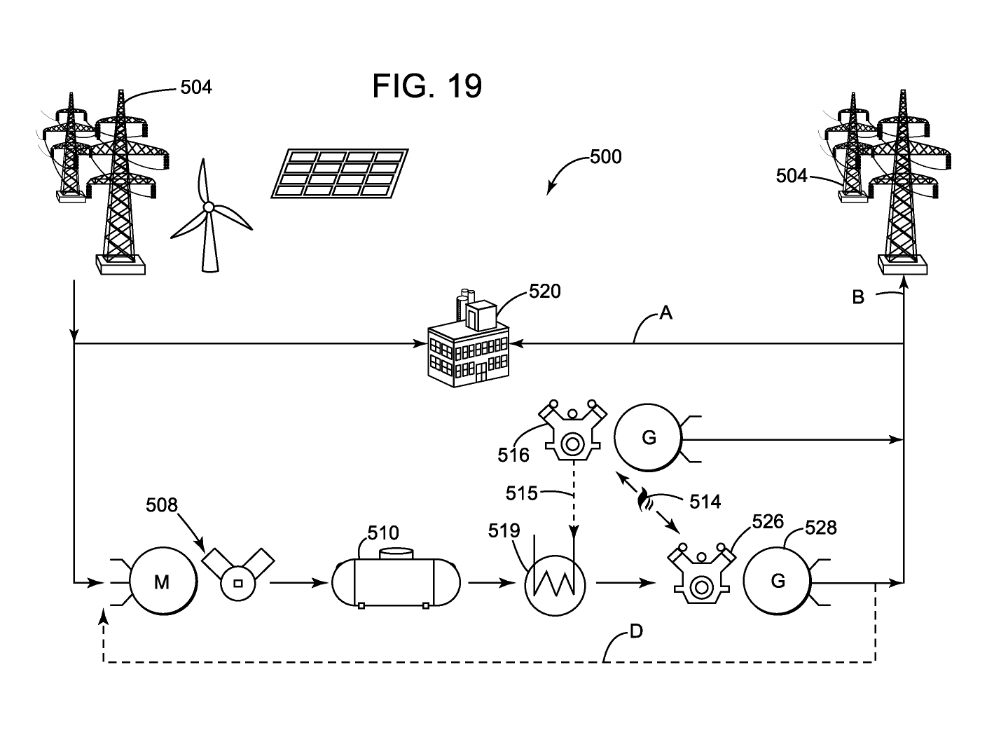

As shown in FIG. 19, the system 500 can include an electrical coupling (D) between the output of the generator 528 and the input of the motor-compressor 508. Using the path (D), at least a portion of any excess power generated by the generator 528 can be fed back to the input of the motor-compressor system 508. The system 500 can thus be configured to use excess generated power to compress additional air into the storage tanks 510, for example when the grid 504 is down due to an outage and it is not possible to sell power back to the grid. The connection path (D) also allows the system 500 to continue running even when the compressor side 508 of the system is unable to draw power from the grid 504 or from renewable sources 506. In such cases, the generator 528 uses the fuel supply 514 to continue supplying power to the end user 520. A portion of the power generated is provided to meet end user demand while the remaining portion is fed back to the compressor 508 to generate compressed air for use in air hybrid operation of the expander 526. In some instances, for example when grid power is very expensive and renewable sources are not producing sufficient power, it can be more cost effective to use a portion of the engine-generator 516 output and/or the expander-generator 528 output to drive the motor-compressor 508.

As noted above, the systems disclosed herein can be supplied with input power from a power grid as well as from one or more renewable energy sources such as wind, hydroelectric, and solar power. One advantage of using renewable energy sources is that they can allow the motor-compressor to run for a longer period of time as compared with the period during which power from the grid can be purchased at off peak prices. For example, off peak grid pricing is typically available for approximately 8 hours per day. With renewable sources, on the other hand, the system can charge the air storage tanks up to a full 24 hours per day. Thus, in some embodiments, renewable sources can allow the motor-compressor to run 3 times longer than when driven exclusively using off peak grid power. As a result, more air can be stored, the cost of compression can be minimized, and the size of the compressor can be reduced, resulting in a decreased cost of system components.

In various portions of the preceding description, reference is made to purchasing power from the grid during off-peak periods. It will be appreciated that, in jurisdictions in which negative pricing is available, the system, the end user, and/or an owner or operator of the system can be paid to consume power from the grid during such off-peak hours instead of purchasing the power.

The compressor and the generator in the systems described herein can each include a split-cycle engine or can be part of the same split-cycle engine. In other embodiments, one or both of the compressor and the generator can include conventional engine technology. Various other systems or devices can be used instead or in addition including, for example, turbine engines and/or air expanders of the type described above.

Any of the systems disclosed herein can include one or more controllers or digital data processing systems (e.g., including one or more processors coupled to memory and/or storage) configured to control the system to operate in any of a variety of operating modes. For example, a controller can monitor grid purchase price, grid sale price, end user electrical demand, end user heat demand, fuel price, stored air quantity, renewable output level, current and forecasted weather, and/or various other factors to make a determination as to which operating mode should be used at any given time and to switch between various modes.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

1. A power system, comprising:
a generator configured to burn fuel and generate electrical power;
a first connection between the generator and a power grid through which power generated by the generator can be supplied to the power grid;
a second connection between the generator and an end user through which power generated by the generator can be supplied to the end user; and
a controller configured to operate the generator within a high efficiency range such that the end user is supplied with power through the second connection and such that any power generated in excess of the end user's demand is supplied to the grid through the first connection.

2. The system of claim 1, further comprising:
a third connection between the power grid and the end user through which grid power can be supplied to the end user;
wherein the controller is configured to:
during off-peak hours, deactivate the generator such that the end user is supplied with power only through the third connection; and
during on-peak hours, operate the generator within a high efficiency range such that the end user is supplied with power through the second connection and such that any power generated in excess of the end user's demand is supplied to the grid through the first connection.

3. The system of claim 1, wherein the controller is configured to maintain the generator at full load during on-peak hours.

4. The system of claim 1, wherein the controller is configured to maintain the generator at or above 75% of its rated maximum efficiency during on-peak hours.

5. The system of claim 1, wherein the controller is configured to maintain the generator at or above 80% of its rated maximum efficiency during on-peak hours.

6. The system of claim 1, wherein the controller is configured to maintain the generator at or above 90% of its rated maximum efficiency during on-peak hours.

7. The system of claim 1, wherein the generator comprises a conventional reciprocating engine generator.

8. The system of claim 1, wherein the generator comprises a split-cycle engine generator.

9. The system of claim 1, wherein the generator comprises a turbine engine generator.

10. The system of claim 1, wherein the generator comprises a standalone expander engine generator.

11. A power generation method, comprising:
operating a generator within a high efficiency range to supply power generated by the generator to a power grid via a first connection between the generator and the power grid and to supply power generated by the generator to an end user via a second connection between the generator and the end user, such that any power generated in excess of a demand of the end user is supplied to the grid through the first connection.

12. The method of claim 11, further comprising:
during an on-peak period, operating the generator within the high efficiency range to supply power generated by the generator to the power grid via the first connection between the generator and the power grid and to supply power generated by the generator to the end user via the second connection between the generator and the end user, such that any power generated in excess of a demand of the end user is supplied to the grid through the first connection; and
during an off-peak period, deactivating the generator such that the end user is supplied with power only through a third connection between the power grid and the end user through which grid power can be supplied to the end user.

13. The method of claim 12, wherein said operating and deactivating steps are performed under the control of a digital data processing system coupled to the generator.

14. The method of claim 11, wherein operating the generator comprises burning fuel to generate electrical output power.

15. The method of claim 11, wherein operating the generator within the high efficiency range comprises maintaining the generator at full load.

16. The method of claim 11, wherein operating the generator within the high efficiency range comprises maintaining the generator at or above 75% of its rated maximum efficiency.

17. The method of claim 11, wherein operating the generator within the high efficiency range comprises maintaining the generator at or above 80% of its rated maximum efficiency.

18. The method of claim 11, wherein operating the generator within the high efficiency range comprises maintaining the generator at or above 90% of its rated maximum efficiency.

19-49. (canceled)
